(19) United States
(12) Patent Application Publication
(10) Pub. No.: US 2017/0122254 A1
(43) Pub. Date: May 4, 2017

(54) AN INTERNAL COMBUSTION ENGINE HEAT ENERGY RECOVERY SYSTEM

(71) Applicant: KERBS AutoTech Pty Ltd

(72) Inventors: Michael John Urch, Menai, New South Wales (AU); Stephen Bennett, Mosman, New South Wales (AU)

(21) Appl. No.: 15/323,000

(22) PCT Filed: Jun. 29, 2015
(86) PCT No.: PCT/AU2015/000371

§ 371 Date: Dec. 29, 2016

(30) Foreign Application Priority Data
Jun. 30, 2014 (AU) 2014902498
Aug. 28, 2014 (AU) 2014903414

(51) Int. Cl. F02G 5/04; F01K 23/10; B60K 6/24; F01N 5/02; F02B 37/10; B60K 6/26; F01K 23/06; F01K 27/02

(52) U.S. Cl. CPC F02G 5/04; F01K 23/065; F01K 23/10; F01K 27/02; F01N 5/025; F02B 37/10; B60K 6/26; B60K 6/24; F02G 2260/00; F02G 2262/00

(57) ABSTRACT

An internal combustion engine heat energy recovery system (1) comprises a first heat exchanger (20) arranged in heat communication with at least one heat energy source of an internal combustion engine (10) and with a working fluid of the system (1) for the transfer of heat energy from the heat energy source to the working fluid of the system (1). A turbine (30) is arranged in fluid communication with the working fluid heated in the first heat exchanger (20) for the expansion of the working fluid to produce shaft power. A second heat exchanger (40) is arranged in heat communication with the expanded working fluid to remove waste heat therefrom and transfer it to an external source such as the atmosphere. A first compressor (50) is arranged in fluid communication with the working fluid exiting the heat exchanger for increasing the pressure of the cooled working fluid prior to its entry into the first heat exchanger (20). The working fluid of the system is a substantially supercritical fluid.

### FIELD

The present invention relates to an internal combustion engine heat energy recovery system that reclaims the heat normally wasted from the combustion process in an internal combustion engine and uses a heat engine to transform it into a useful form of energy such as electricity. The invention has been primarily developed for automobile racing engines such as are used in Formula 1, and will be described primarily in these terms. However, it is envisaged that the invention also has other applications such as in hybrid cars, transport vehicles (such as trucks, buses, trains, planes), generators (diesel generator sets) and most internal combustion engines.

This provisional patent application refers to a digitally controlled motor device with storage that is described in the Applicant's corresponding Australian provisional patent application no. 2014902495 entitled “Digitally Controlled Motor Device With Storage” filed on 30 Jun. 2014, and to the corresponding International (PCT) patent application titled “Digitally Controlled Motor Device With Storage” as filed on 29 Jun. 2015, the entire contents of which are incorporated herein by reference.

### BACKGROUND

The price of energy, in particular oil based fuels such as petroleum and diesel, that powers most vehicles on the road, ocean or air is steadily increasing. Large sectors of the economy are affected by the rising cost of transportation and governments are continually introducing more rigid environmental standards for engine emissions control.

A petroleum internal combustion engine is typically less than 30% efficient at converting fuel energy into mechanical shaft work with typically more than 60% of the energy wasted through the exhaust and radiator. A majority of the heat energy in the engine is wasted, presenting an opportunity for reclaiming this heat energy and transforming it into a useful format such as electricity to help propel the vehicle and reduce energy consumption and emissions.

Prior art technologies have focused primarily on reclaiming heat in the exhaust gases which is typically only 65% of the total heat wasted. Most of these technologies use a heat engine in the form of a steam Rankine cycle to convert this heat into electricity. The efficiency of this form of Rankine cycle energy conversion typically varies from 5% to 20%. While this method has been shown to generate useable amounts of energy, the size, complexity and in particular the weight of the components required in the system have been too high compared to the energy benefit of the system. Automobile manufacturers have tried and tested this technology with some success, however, to the Applicant's knowledge, none have proven to be commercially viable and entered into production.

Another form of reclaiming and harnessing wasted heat energy is the use of a turbo charger located directly downstream of the engine and having a turbine powered by the hot expanding exhaust gas. The turbine is directly coupled to a compressor which is arranged to provide compressed air into the engine intake so as to induce more air into the engine.

Turbo charged engines have traditionally been used on petroleum based sports cars since their reliability has been questionable and they generally increase fuel consumption. The current trend is to manufacture vehicles with a reduced engine size and to utilise a turbo charger to make up the shortfall in engine torque and power. While this has reduced fuel consumption and emissions, the turbo chargers are not very efficient at converting the wasted heat energy into useable energy.

The FIA Regulations governing Formula 1 racing for the 2014 season permit the use of a motor generator unit to recover the kinetic energy lost in braking (known as MGU-K) and the heat energy lost from the engine (known as MGU-H). Employing these technologies has allowed the Formula 1 series to “go green” and the cars are maintaining similar fast lap times and speeds with a much smaller hybrid engine setup which saves more than 30% fuel consumption. The rules are quite flexible in the MGU-H meaning that not just traditional turbo charging but other forms of using that wasted heat energy are permitted. Current technologies employed for this purpose utilise an electronic turbo (charger) that is coupled to the motor generator to power it at low speeds to reduce turbo lag and generate electricity at high speeds when the turbine is spinning faster than a maximum permitted speed. Any additional power that is generated can be stored up to 4 MJ per lap and used to power the MGU-K to propel the car forwards with more power. There is no limit in the Regulations to the excess power generated in the MGU-H if it can be fed to the MGU-K for increased power and speed.

The harnessing of wasted heat energy using the known technologies has provided significant performance benefits for lower fuel consumption and emissions. However, the amount of converted useful energy is still only a small proportion of the total energy that is wasted. Furthermore, the current technologies used in the 2014 Formula 1 season have had the undesirable consequence of diminishing the noise level of the V6 engine, already reduced from the distinctive noise level of the V8 engines used in previous seasons, a factor that has proven to be controversial in spectator enjoyment of the sport.

### OBJECT OF INVENTION

It is the object of the present invention to improve upon the prior art or to provide a useful alternative thereto.

### SUMMARY OF INVENTION

There is disclosed herein an internal combustion engine heat energy recovery system, comprising:

a first heat exchanger arranged in heat communication, more preferably fluid communication, with at least one heat energy source of an internal combustion engine and with a working fluid of the system for the transfer of heat energy from the heat energy source to the working fluid of the system;

a turbine arranged in fluid communication with the working fluid heated in the first heat exchanger for the expansion of the working fluid to produce shaft power;

a second heat exchanger arranged in heat communication, more preferably fluid communication, with the expanded working fluid to remove waste heat therefrom and transfer it to an external source such as the atmosphere; and a first compressor arranged in fluid communication with the working fluid exiting the heat exchanger for increasing the pressure of the cooled working fluid prior to its entry into the first heat exchanger, wherein the working fluid of the system is a supercritical fluid.

There is disclosed herein an internal combustion engine heat energy recovery system, comprising:

a first heat exchanger arranged in heat communication, more preferably fluid communication, with a first heat energy source of an internal combustion engine and with a second heat energy source of the internal combustion engine for the transfer of heat energy from the first heat energy source to the second heat energy source;

an intermediary heat exchanger arranged in heat communication with the second heat energy source heated in the first heat exchanger and with a working fluid of the system for the transfer of heat energy from the second heat energy source to the working fluid of the system;

a turbine arranged in fluid communication with the working fluid heated in the intermediary heat exchanger for the expansion of the working fluid to produce shaft power;

a second heat exchanger arranged in heat communication, more preferably fluid communication, with the expanded working fluid to remove waste heat therefrom and transfer it to an external source such as the atmosphere; and a first compressor arranged in fluid communication with the working fluid exiting the heat exchanger for increasing the pressure of the cooled working fluid prior to its entry into the intermediary heat exchanger, wherein the working fluid of the system is a substantially supercritical fluid.

The system has the advantage that a supercritical working fluid has a high density which allows the system to operate at a high working temperature and pressure in comparison to a steam Rankine cycle, causing a high speed of rotation of the turbine blades. This increases the amount of shaft power produced by the turbine for its size and weight.

Preferably, the working fluid is supercritical carbon dioxide. Alternatively, the working fluid is supercritical water or other refrigerants.

Preferably, the system includes a generator operatively associated with the turbine for converting the shaft power produced by the turbine into electrical power. The generator can be substantially smaller than may be required in a Rankine cycle based energy recovery system by virtue of the increased shaft power generated by the turbine.

Preferably, the system includes a battery adapted for storing the electrical power generated by the generator.

Preferably, the at least one or first heat energy source of the internal combustion engine is exhaust gas.

Preferably, the at least one or second heat energy source of the internal combustion engine is engine coolant. Preferably, the system includes a coolant recirculation conduit arranged to recirculate engine coolant cooled by the first heat exchanger back to the internal combustion engine, most preferably inside the engine head in a water circuit. Alternatively the working fluid may be circulated inside the engine in a water circuit.

Preferably, the at least one or first waste heat energy source of the internal combustion engine is engine oil. Preferably, the system includes an engine oil recirculation conduit arranged to recirculate engine oil cooled by the first heat exchanger back to the internal combustion engine, more preferably inside the engine in an oil circuit.

Preferably, the at least one waste heat energy source is condenser heat emitted by the air conditioning system of a vehicle.

Preferably, the system is arranged to recover heat energy from a plurality of heat energy sources of the internal combustion engine.

In an embodiment, the first heat exchanger is arranged in heat communication, more preferably fluid communication, with each of a first heat energy source in the form of engine exhaust gas and a second waste heat energy source in the form of engine coolant. Preferably, the first heat exchanger comprises an exhaust gas receiving heat exchanger for the transfer of heat energy from the exhaust gas to the working fluid, and a coolant receiving heat exchanger for the transfer of heat energy from the engine coolant to the working fluid.

Preferably, the first heat exchanger further includes an oil receiving heat exchanger arranged in heat communication, more preferably fluid communication, with a further heat energy source in the form of engine oil for the transfer of heat energy from the engine oil to the working fluid.

Preferably, the first compressor is operatively associated with an output shaft of the turbine so as to be driven by the turbine.

Alternatively, the system includes a motor arranged to draw electrical power from the battery. Preferably, the first compressor is operatively associated with and driven by the motor.

In another embodiment, the first compressor is driven by shaft power produced by the internal combustion engine.

In an alternative embodiment, the first compressor is driven directly by the electrical power generated by the generator.

Preferably, the system further includes a digitally controlled motor device with storage arranged to draw electrical power from the generator. Preferably, the digitally controlled motor device comprises a fly wheel for the storage of mechanical power. Preferably, the digitally controlled motor device further includes a rotor arranged in magnetic communication with the fly wheel. Preferably, the fly wheel and the rotor are adapted to operate at different speeds of rotation. In an embodiment, at least a portion of electrical power generated by the digitally controlled motor device is employed to drive the first compressor. Preferably, the digitally controlled motor device is arranged to divert at least a portion of electrical power generated therein to the battery for storage.

Preferably, the system further includes a second compressor in fluid communication with an air supply and a first intercooler arranged for cooling compressed air exiting the second compressor, wherein the cooled compressed air is arranged in fluid communication with an intake of the internal combustion engine.

Preferably, a portion of the working fluid cooled by the second heat exchanger is diverted through the intercooler prior to its entry into the first compressor for cooling the compressed air. Preferably, the system includes a second intercooler in heat communication, more preferably fluid communication, with the first intercooler, the first intercooler and second intercooler being arranged in a closed loop through which an intercooler fluid flows, wherein a portion of the working fluid cooled by the second heat exchanger is diverted through the second intercooler for heat exchange with the intercooler fluid prior to its entry into the first compressor. Preferably, the intercooler fluid is water.

In an embodiment, the second compressor is driven directly by electrical power generated by the generator. In another embodiment, the second compressor is driven by a motor powered by electrical power stored in the battery.

Preferably, the system further includes a motor generator powered by a portion of the electrical power stored in the battery. Preferably, the motor generator is operatively associated with a drive shaft of a vehicle powered by the internal combustion engine. Preferably, the motor generator is adapted to draw electrical power from the battery to rotate the drive shaft of the vehicle.

Preferably, a portion of the electrical power generated by the digital gearbox motor is used to drive the first compressor and another portion of the electrical power is used to drive the second compressor.

Preferably, the system includes a first digitally controlled motor device with storage arranged in operable communication with both the turbine and the first compressor for driving the first compressor and further includes a second digitally controlled motor device with storage operatively associated with the drive shaft of the vehicle and adapted to draw electrical power from the battery to rotate the drive shaft of the vehicle.

An advantage of this embodiment when utilised in a Formula 1 racing car is that waste heat energy can be recovered from the engine without the use of a turbo charger directly in the engine exhaust. This preserves the sound level of the engine whilst maximising energy recovery and reducing fuel emissions.

In an embodiment, the working fluid is circulated through the internal combustion engine in heat communication with at least one engine component for the transfer of heat energy from the at least one engine component to the working fluid prior to its entry into the first heat exchanger. Preferably, the at least one engine component is a combustion cylinder. Alternatively it may be engine oil.

Preferably, the system further comprises a recuperator arranged in heat communication, preferably fluid communication, with the working fluid upon its exit from the internal combustion engine for the transfer of heat energy to the working fluid prior to its entry into the first heat exchanger. More preferably, the recuperator is also arranged in heat communication, preferably fluid communication, with the expanded working fluid for the transfer of heat energy from the working fluid prior to its entry into the second heat exchanger.

In an alternative embodiment, the recuperator is arranged in heat communication, preferably fluid communication, with the working fluid upon its exit from the first compressor for the transfer of heat energy to the working fluid prior to its entry into the intermediary heat exchanger. More preferably, the recuperator is also arranged in heat communication, preferably fluid communication, with the expanded working fluid for the transfer of heat energy from the working fluid prior to its entry into the second heat exchanger.

There is further disclosed herein an internal combustion engine heat energy recovery system, comprising:

an internal combustion engine heat exchanger arranged in heat communication with at least one component of the internal combustion engine for the transfer of heat energy from the at least one component of the internal combustion engine to a working fluid of the system, a first heat exchanger arranged in heat communication, more preferably fluid communication, with the working fluid heated by the internal combustion heat exchanger and in heat communication, preferably fluid communication, with at least one further heat energy source of the internal combustion engine for the transfer of heat energy from the heat energy source to the working fluid of the system;

a turbine arranged in fluid communication with the working fluid heated in the first heat exchanger for the expansion of the working fluid to produce shaft power;

a recuperator arranged in fluid communication with the expanded working fluid from the turbine to recuperate the heat therein, and further being arranged in fluid communication with the working fluid heated by the internal combustion engine heat exchanger to cool the working fluid prior to its entry into the first heat exchanger;

a second heat exchanger arranged in fluid communication with the working fluid heated in the recuperator for the removal of waste heat therefrom and transfer it to an external source such as the atmosphere; and

a first compressor arranged in fluid communication with the working fluid exiting the second heat exchanger for increasing the pressure of the cooled working fluid prior to its entry into the internal combustion engine heat exchanger, wherein the working fluid of the system is a supercritical fluid.

Preferably, the internal combustion engine heat exchanger is or includes a conduit arranged in heat communication with the at least one component of the internal combustion engine. Preferably, the conduit is arranged to transport the working fluid through the internal combustion engine.

Preferably, the system further includes a third heat exchanger in fluid communication with the working fluid exiting the first compressor, in which the working fluid passing through the third heat exchanger is in heat communication with ambient air for cooling the working fluid. Preferably, the system further comprises a second compressor in fluid communication with an air supply and a first intercooler arranged for cooling compressed air exiting the second compressor, wherein the cooled compressed air is in heat communication with the working fluid exiting the third heat exchanger for cooling the compressed air prior to its entry into the internal combustion engine.

Preferably, the internal combustion engine heat exchanger is located inside the internal combustion engine. Preferably, the at least one engine component is either a combustion cylinder or engine oil.

Preferably, the second heat exchanger transfers the waste heat from the working fluid to the atmosphere.

There is further disclosed herein an internal combustion engine heat energy recovery system, comprising:

a first heat exchanger arranged in heat communication, more preferably fluid communication, with at least one heat energy source of an internal combustion engine and with a working fluid of the system for the transfer of heat energy from the heat energy source to the working fluid of the system;

a turbine arranged in fluid communication with the working fluid heated in the first heat exchanger for the expansion of the working fluid to produce shaft power;

a second heat exchanger arranged in heat communication, more preferably fluid communication, with the expanded working fluid to remove waste heat therefrom and transfer it to the atmosphere; and a first compressor arranged in fluid communication with the working fluid exiting the heat exchanger for increasing the pressure of the cooled working fluid prior to its entry into the first heat exchanger, wherein the working fluid of the system is a substantially supercritical fluid.

There is disclosed herein an internal combustion engine heat energy recovery system, comprising:

a first heat exchanger arranged in heat communication, more preferably fluid communication, with at least one heat energy source of an internal combustion engine and with a working fluid of the system for the transfer of heat energy from the heat energy source to the working fluid of the system;

a turbine arranged in fluid communication with the working fluid heated in the first heat exchanger for the expansion of the working fluid to produce shaft power;

a second heat exchanger arranged in heat communication, more preferably fluid communication, with the expanded working fluid to remove waste heat therefrom and transfer it to the atmosphere; and a first pressurising device arranged in fluid communication with the working fluid exiting the heat exchanger for increasing the pressure of the cooled working fluid prior to its entry into the first heat exchanger, wherein the working fluid of the system is a substantially supercritical fluid.

In an embodiment, the pressurising device is a heat pump.

Preferably, the working fluid is supercritical at least prior to its entry into the turbine.

### BRIEF DESCRIPTION OF DRAWINGS

Preferred forms of the present invention will now be described, by way of example only, with reference to the accompanying drawings wherein:

FIG. 1 is a schematic of a first embodiment of the internal combustion engine heat energy recovery system in which heat is recovered from the engine exhaust gas and converted to perform useful work;

FIG. 2 is a schematic of a second embodiment of the internal combustion engine heat energy recovery system in which heat is recovered from the engine coolant and converted to perform useful work;

FIG. 3 is a schematic of a third embodiment of the internal combustion engine heat energy recovery system in which heat is recovered from the engine oil and converted to perform useful work;

FIG. 4 is a schematic of a further embodiment in which heat is recovered from the engine coolant and the exhaust gas;

FIG. 5 is a schematic of a further embodiment in which heat is recovered from the engine coolant, engine oil and exhaust gas;

FIG. 6 is a schematic of a further embodiment in which heat is recovered from the engine coolant and exhaust gas, with the compressor driven by the engine;

FIG. 7 is a schematic of a further embodiment in which heat is recovered from the engine coolant and exhaust gas, with the compressor driven directly by the turbine;

FIG. 8 is a schematic of a further embodiment in which the heat is recovered from the engine coolant and exhaust gas and converted to perform useful work in a digitally controlled motor device with storage, with the compressor being driven by the digitally controlled motor device;

FIG. 9 is a schematic of the digitally controlled motor device with storage of FIG. 8;

FIG. 10 is a schematic of a further embodiment in which heat is recovered from the engine coolant and exhaust gas and converted to perform useful work, with the compressor driven directly by the turbine which also drives a second compressor to induce more air into the engine;

FIG. 11 is a schematic of a variant of the system of FIG. 10, further including a turbo intercooler and an intermediate heat exchanger;

FIG. 12 is a variant of a schematic of the system of FIG. 10 in which the second compressor is powered by an electric motor;

FIG. 13 is a schematic of a variant of the system of FIG. 10 in which the first compressor is directly driven by the digitally controlled motor device with storage and the second compressor is indirectly driven by the digitally controlled motor device with storage;

FIG. 14 is a schematic of a variant of the embodiment of FIG. 13 in which a second digitally controlled motor device with storage is used to drive a vehicle powered by the internal combustion engine directly;

FIG. 15 is a schematic of a variant of the embodiment of FIG. 14 further including a heat exchanger for providing cooling to a vehicle driver; and

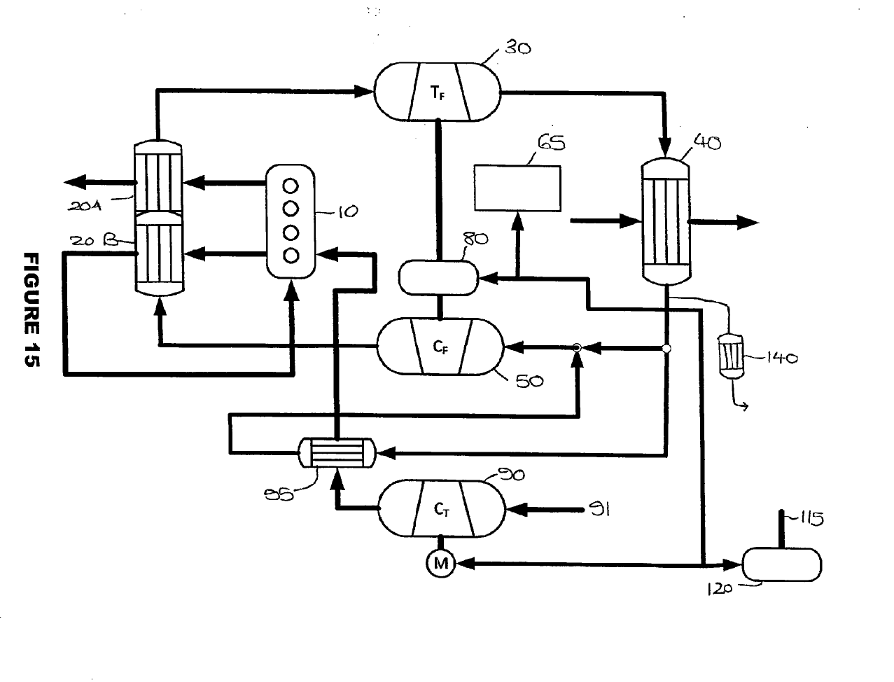

FIG. 16 is a schematic of a variant of the embodiment of FIG. 1 in which the compressor is replaced by a heat pump.

FIG. 17 is a schematic of a variant of the embodiment of FIG. 10 in which the system includes an intercooler for cooling compressed air exiting the second compressor, a first digitally controlled motor device with is connected to the turbine shaft and a further digitally controlled motor device is connected to a vehicle drive shaft.

FIG. 18 is a schematic of a variant of the embodiment of FIG. 17 in which the working fluid is circulated through the internal combustion engine for heat exchange therein and a recuperator heat exchanger is installed after the turbine to preheat the working fluid prior to its entry into the first heat exchanger.

FIG. 19 is a schematic of a variant of the embodiment of FIG. 18 in which the working fluid is circulated through an aftercooler prior to its entry into the internal combustion engine.

FIG. 20 is a schematic of a variant of the embodiment of FIG. 18 in which the internal combustion engine is normally aspirated and engine coolant is circulated through an internal combustion engine heat exchanger and through a radiator allowing retrofitting to current engines.

FIG. 21 is a schematic of a variant of the embodiment of FIG. 20 in which the radiator has been removed from the coolant circuit and indirectly replaced by the second heat exchanger allowing retrofitting to current engines.

FIG. 22 is a schematic of a variant of the embodiment of FIG. 18 in which the working fluid exchanges heat with the engine coolant inside the internal combustion engine heat exchanger rather than circulate through the internal combustion engine allowing retrofitting to current engines.

FIG. 23 is a schematic of a variant of the embodiment of FIG. 22 in which the working fluid absorbs heat in a recuperator heat exchanger arranged between the turbine and the second heat exchanger and rejects heat via a coolant circuit to atmosphere. This allows retrofitting to current engines.

FIG. 24 is a schematic of a variant of the embodiment of FIG. 23 allowing retrofitting to current engines.

FIG. 25 is a schematic of a variant of the embodiment of FIG. 23 in which the internal combustion engine is a normally aspirated engine connected to the system via a digitally controlled motor device with storage. This allows retrofitting to current engines.

FIG. 26 is a schematic of a variant of the embodiment of FIG. 17 in which forced induction air is cooled below ambient temperatures to reject heat gained from the first compressor and the system includes an electronic expansion valve for controlling the vaporization of gas inside an intercooler and cooling it down at rapid rates using the latent heat of vaporization of the working fluid.

### DESCRIPTION OF EMBODIMENTS

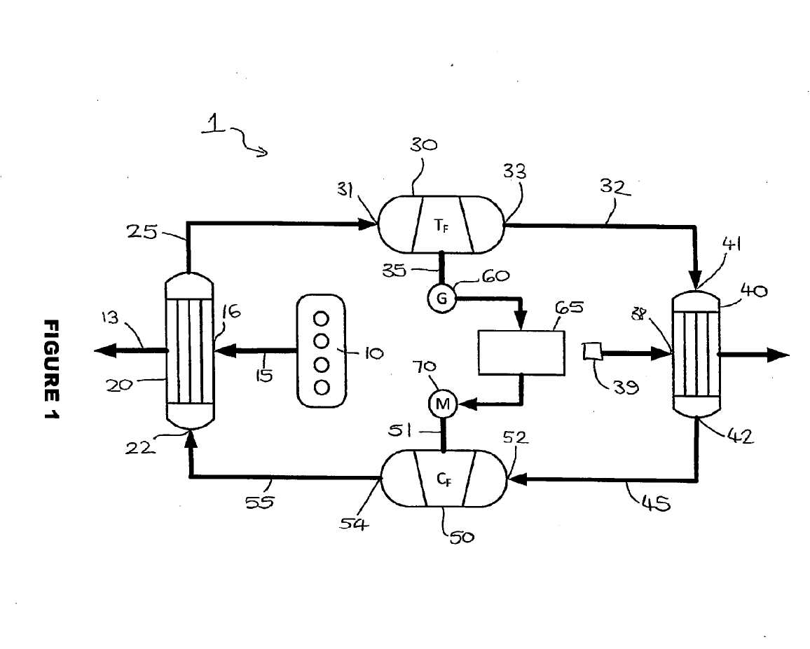

FIG. 1 shows a schematic representation of a first embodiment of an internal combustion engine heat energy recovery system 1 for generating useful work and electrical power from waste heat in the exhaust gas issuing from the exhaust of an internal combustion engine 10. The system 1 includes a first “hot” heat exchanger 20 at which the exhaust gas enters the system 1. The internal combustion engine 10 has an exhaust conduit 15 that extends from the engine exhaust to an inlet 16 of the hot heat exchanger 20. The heat exchanger 20 is a tube-in-tube heat exchanger in which an outer tube winds a helical path around an inner tube that is in heat and fluid communication with the exhaust conduit 15 and which carries the exhaust gas. The outer tube carries the working fluid of the system 1 through the heat exchanger 20. The working fluid is supercritical carbon dioxide existing at high temperature and pressure, typically above 20 Bar. The waste heat in the exhaust gas in the inner tube transfers heat to the supercritical fluid in the outer tube of the hot heat exchanger 20. The cooled exhaust gas in the inner tube is then exhausted to the atmosphere via the heat exchanger exhaust conduit 13.

As shown in FIG. 1, the system 1 also includes a turbine 30, a second “cold” heat exchanger 40, a compressor 50, a generator 60, a battery 65 and a motor 70. A working fluid transport conduit 25 extends between the hot heat exchanger 20 and an intake 31 of the turbine 30 for transporting the heated supercritical working fluid exiting the heat exchanger 20 to the turbine inlet 31 at high temperature and pressure. The supercritical working fluid impinges on the turbine blades (not shown) causing them to rotate at high speed, is expanded in the turbine and exits the turbine into a transport conduit 32 that extends between an exit 33 of the turbine and an inlet 41 of the cold heat exchanger 40. The expanded supercritical working fluid exits the turbine at a lower pressure and temperature, typically at 7 MPa and 400 degrees Celsius. A supply of cool air 39 is arranged in heat and fluid communication with an inlet 38 of the cold heat exchanger 40. The heat exchanger 40, shown only schematically in the Figures, is a tube-in-tube heat exchanger in which an outer tube winds a helical path around an inner tube that is adapted for heat and fluid communication with the inlet 38 and which carries the cool air through the heat exchanger 40. The outer tube carries the supercritical working fluid of the system 1 through the heat exchanger 40. As the supercritical working fluid flows through the heat exchanger 40, it transfers heat energy to the cool air in the inner tube. A further transport conduit 45 extends between an exit 42 of the cold heat exchanger 40 and an intake 52 of the compressor 50. The cool temperature, low pressure supercritical working fluid passes through the transport conduit 45 into the compressor intake 52 where it is compressed to a high pressure such as 20 MPa and medium temperature such as 250 degrees Celsius. The supercritical working fluid then exits the compressor 50 into a transport conduit 55 that extends between an exit of the compressor 54 and an outer tube inlet 22 of the “hot” heat exchanger 20, whereby the supercritical working fluid loop is completed.

The turbine 30 has an output shaft 35. The generator 60 is mounted on the output shaft 35 for converting the rotation of the shaft to electrical power. The generator 60 is in electrical communication with the battery 65 such that electricity generated by the generator 60 is stored in the battery 65. The battery 65 is typically capable of storing up to 4 MJ of electrical power.

In the embodiment of FIG. 1, the battery 65 is in electrical communication with the motor 70. The motor 70 is arranged in operable association with an input shaft 51 of the compressor 50. The electrical power stored in the battery 65 is used to provide power to the motor 70 for driving the input shaft 51 of the compressor 50 for compressing the supercritical working fluid to a high pressure such as 20 MPa and medium temperature such as 250 degrees Celsius prior to its entry into the transport conduit 55 and the hot heat exchanger 20.

The above system is the simplest embodiment of the invention and is operable to reclaim heat energy wasted in the engine exhaust to further heat a supercritical working fluid to a high temperature and pressure prior to it entering a turbine. Accordingly, the turbine can generate an increased amount of shaft power for its size and weight. Alternatively, the turbine does not need to be as large as would be the case for a cycle having a working fluid operating at lower temperature and pressure to generate a required amount of shaft power.

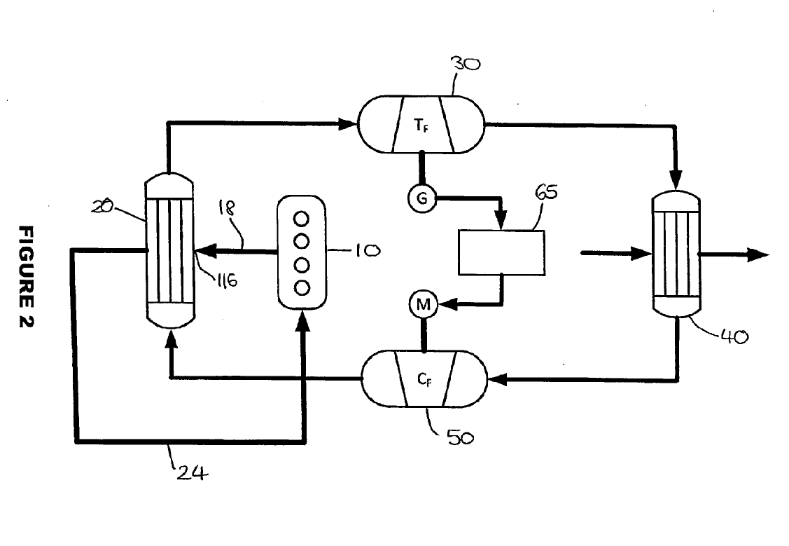

FIG. 2 shows a variation of the system 1 of FIG. 1 in which, rather than engine exhaust gas, the source of heat energy from the internal combustion engine 10 is engine coolant. The engine coolant is warmed in the engine and is diverted therefrom into a coolant conduit 18. The coolant conduit 18 is in heat and fluid communication with an inlet 116 of the hot heat exchanger 20, which is in turn in heat and fluid communication with the inner tube of the heat exchanger 20. Once the engine coolant has passed through the inner tube of the heat exchanger 20 and transferred heat to the supercritical working fluid in the outer tube, it is recirculated via an engine coolant recirculation conduit 24 back to the water coolant intake of the internal combustion engine 10.

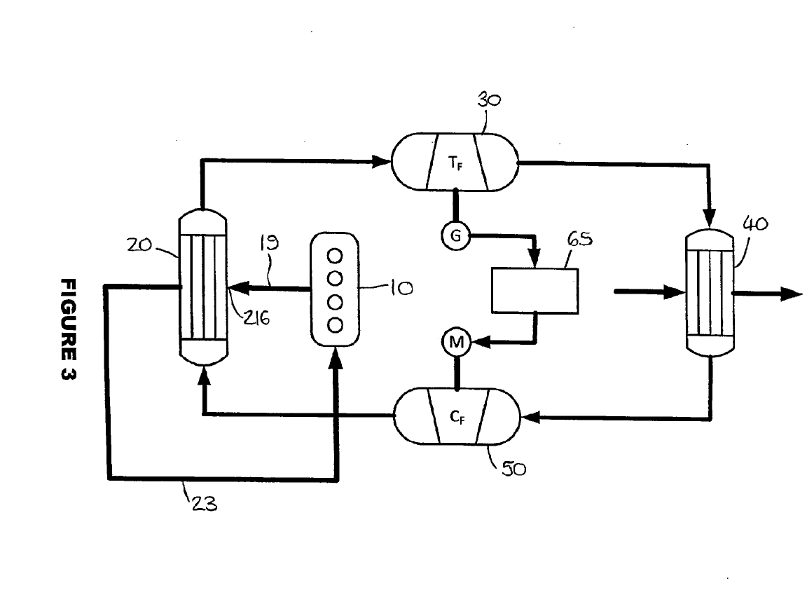

FIG. 3 shows a further variation of the system 1 of FIG. 1 in which the source of heat energy from the internal combustion engine 10 is hot engine oil. The hot engine oil is diverted from an oil sump (not shown) of the internal combustion engine 10 into an oil conduit 19. The oil conduit 19 is in heat and fluid communication with an inlet 216 of the heat exchanger 20. Once the engine oil has passed through the inner tube of the heat exchanger 20 and transferred heat to the supercritical working fluid in the outer tube, the cooled engine oil is fed via an engine oil recirculation conduit 23 back to the oil coolant intake of the internal combustion engine 10.

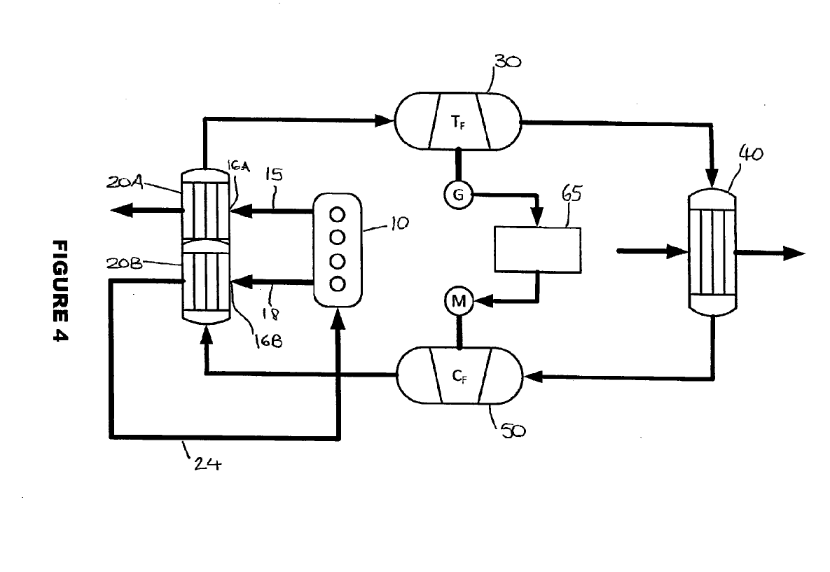

In the embodiment of FIG. 4, heat energy is recovered from both the exhaust gas and the warm engine coolant of the internal combustion engine 10. The hot heat exchanger now consists of a first exhaust gas heat exchanger 20A and an engine coolant heat exchanger 20B arranged in series. Exhaust gas is fed via the exhaust gas conduit 15 into an inlet 16A of the exhaust gas heat exchanger 20A from where it passes through the inner tube of the heat exchanger 20A and the exhaust conduit 13 to the atmosphere. Engine coolant is fed via the engine coolant conduit 18 into an inlet 16B of the engine coolant heat exchanger 20B from where it passes through the inner tube of the heat exchanger 20B and through the engine coolant recirculation conduit 24 back to the engine 10. The supercritical working fluid flows through the heat exchanger 20B and then through the heat exchanger 20A where it is heated by the heat transferred from each of the two heat sources.

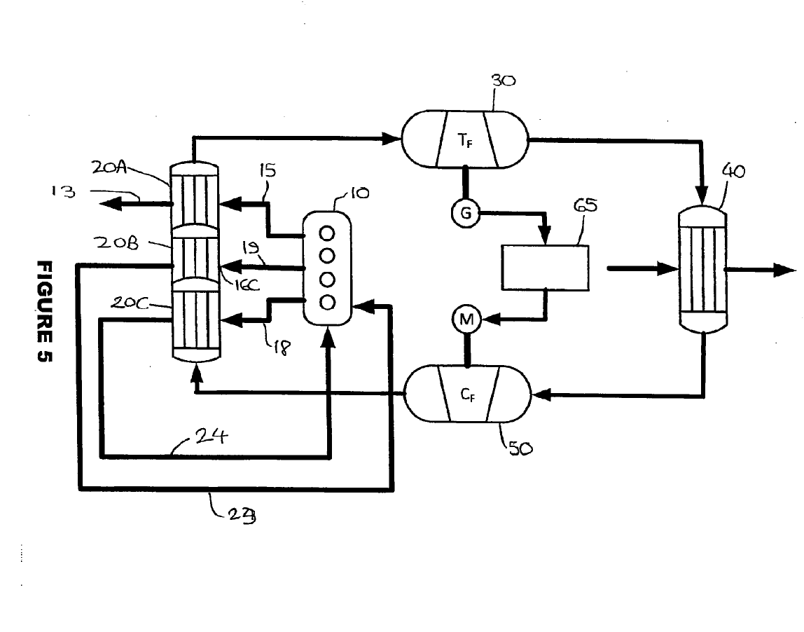

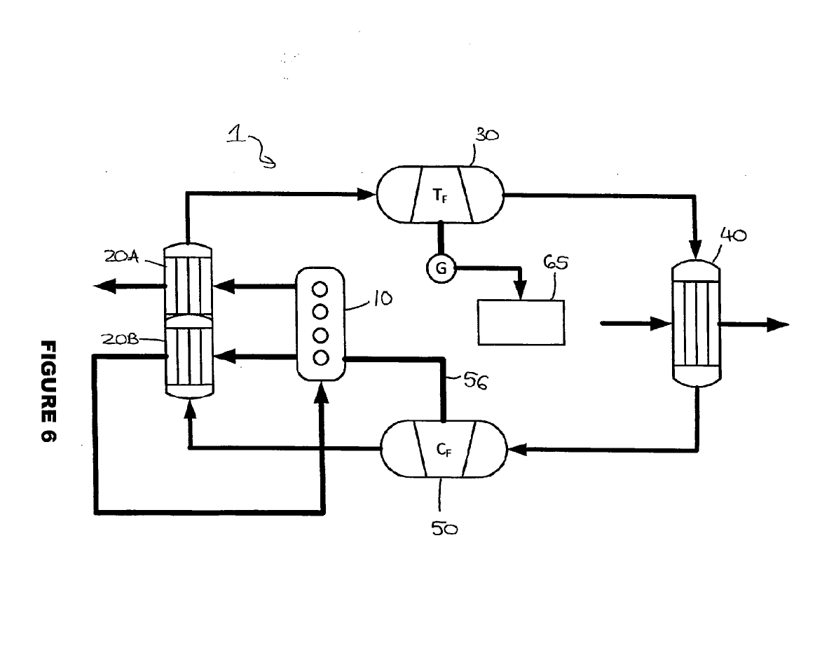

In FIG. 5, heat energy is recovered from the exhaust gas, engine coolant and engine oil of the internal combustion engine 10. The hot heat exchanger includes a further engine oil heat exchanger 20C arranged in series with the exhaust gas heat exchanger 20A and the engine coolant heat exchanger 20B. Engine oil is fed from the engine oil sump (not shown) into the engine oil conduit 19 and into an inlet 16C of the engine oil heat exchanger 20C. Once it has passed through the inner tube of the heat exchanger, the engine oil is recirculated through the engine oil recirculation conduit 23 back into the engine 10. The supercritical fluid flows through the heat exchangers 20B, 20C and 20A in series where it is heated by heat transfer from each heat source in turn. The system shown in FIG. 6 is a variation of the system 1 shown in FIG. 4, with the difference that the compressor 50 is driven via an output shaft 56 of the internal combustion engine 10 via a transmission mechanism such as a belt drive. The reclaiming of heat energy from multiple sources increases the temperature and pressure of the working fluid even further, increasing the efficiency of the turbine in generating shaft power.

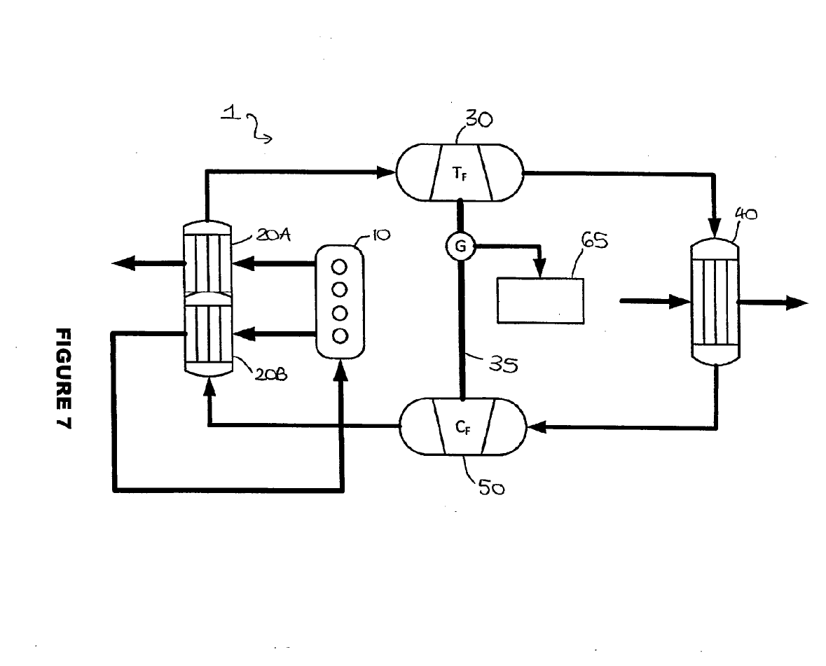

FIG. 7 shows a further variation of the system of FIG. 4 in which the compressor 50 is driven directly via rotation of the output shaft 35 of the turbine 30. This reduces the complexity of the system by removing the need for an additional motor to drive the compressor 50.

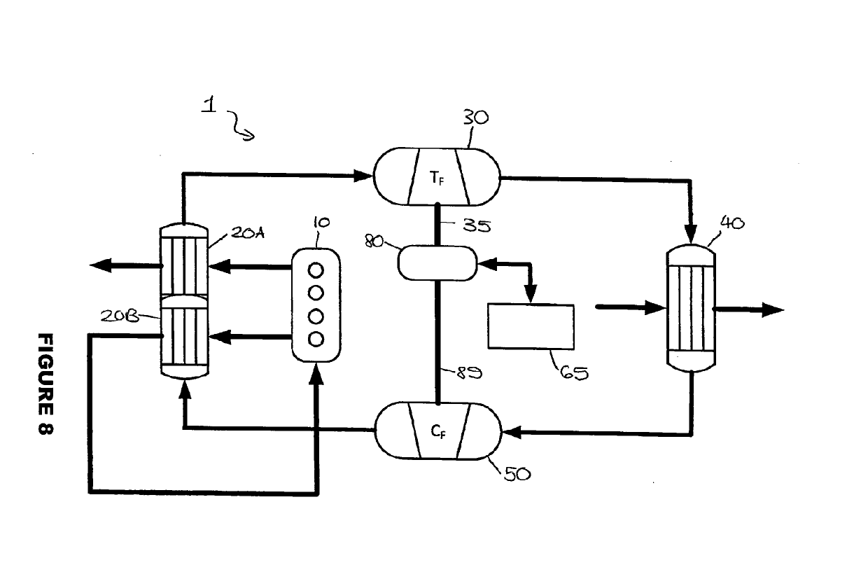

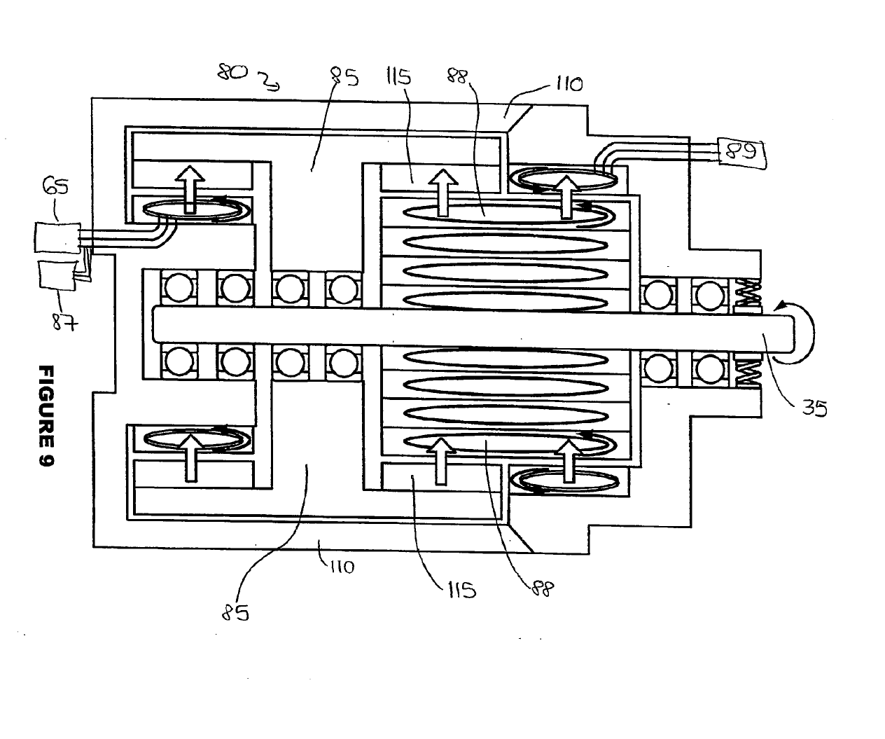

FIG. 8 shows a further variation of the system 1 of FIG. 4 that includes a digitally controlled motor device with storage 80 arranged on the output shaft 35 of the turbine 30. The digitally controlled motor device with storage 80 (hereinafter referred to as the digitally controlled motor device) is adapted to convert electrical power to mechanical shaft power and/or shaft power to electrical power depending on the requirement of the system. In the embodiment of FIG. 8, the digitally controlled motor device 80 is arranged to receive shaft power from the turbine output shaft 35 and to generate electrical power to be stored in the battery 65 for use elsewhere in the recovery system 1 and/or to power a further drive shaft such as the drive shaft 89 of the compressor 50. An example of the digitally controlled motor device 80 is shown in FIG. 9. The digitally controlled motor device 80 comprises a flywheel 85 and an induction rotor 88 arranged in magnetic communication with the flywheel 85. The flywheel 85 and the induction rotor 88 are mounted on the turbine output shaft 35 for rotation about an axis defined by the output shaft 35. The flywheel 85 and induction rotor 88 are housed in a static enclosure 110 that can be used to secure the digital gearbox motor 80 to a stable mounting. The induction rotor 88 is connected to the turbine output shaft 35 for rotation therewith. The induction rotor 88 is in magnetic communication with the flywheel 85 via a set of permanent magnets 115 connected to the flywheel 85. Rotation of the induction rotor 88 generates a magnetic flux in the permanent magnets 115 that causes rotation of the flywheel 85. Acceleration of the flywheel 85 charges the flywheel such that it stores kinetic energy therein, providing a storage aspect of the digitally controlled motor device 80. The digitally controlled motor device 80 is controlled by a digital power controller 87, which may be a programmable logic controller. The kinetic energy can be discharged as electrical power to the battery 65. Alternatively it can be supplied to the digital power controller 87 for use elsewhere in the system. The speed of rotation of the flywheel 85 and induction rotor 88 can be controlled by the digital power controller 87 and can be adapted to rotate at different speeds. The induction rotor 88 is configured to transfer electrical power to the output shaft 89 of the compressor 50 via the at least one digital power controller 87. Therefore, in this embodiment, the turbine 30 and the compressor 50 can be operated at different shaft speeds allowing for optimisation of the operation of each. As the digitally controlled motor device 80 can be mechanically or electronically connected to the heat energy recovery system 1, it can be located in a different location to the system 1 allowing flexibility of use.

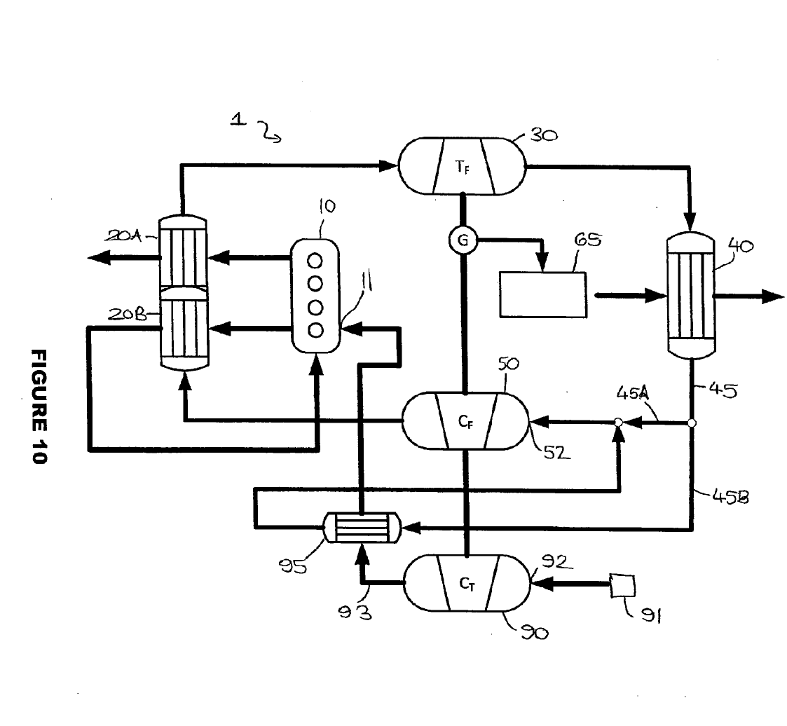

A further variation of the system 1 is shown in FIG. 10. The system 1 includes a second compressor 90 having an inlet 92 that is arranged in fluid communication with a supply of cool air 91. The cool air is compressed in the compressor 90 to a high pressure and temperature and exits into a transport conduit 93 that extends to an air intake 11 of the internal combustion engine 10. The system 1 includes an intercooler 95 arranged downstream of the air compressor 90 in the transport conduit 93 and in heat and fluid communication with the warmed compressed air exiting the compressor 90 such that the warmed compressed air passes through the intercooler 95 before it enters the air intake 11 to provide cooled compressed air to the air intake, increasing the efficiency of the internal combustion engine 10.

In FIG. 10, the working fluid transport conduit 45 extending from the exit 42 of the cold heat exchanger 40 is split into a first conduit portion 45A and a second conduit portion 45B. The first conduit portion 45A extends to the intake 52 of the compressor 50 as in the embodiment of FIG. 4. The second conduit portion 45B extends from the exit 42 of the cold heat exchanger 40 via the intercooler 95 such that low temperature supercritical fluid exiting the cold heat exchanger 40 is passed through the intercooler 95 prior to rejoining the first portion 45A of the conduit 45 upstream of the compressor entrance 52. As such, the supercritical fluid in the conduit portion 45B receives heat from the warm compressed air in the intercooler 95 prior to rejoining the remaining portion of the supercritical fluid in the conduit portion 45A upstream of the compressor entrance inlet 52.

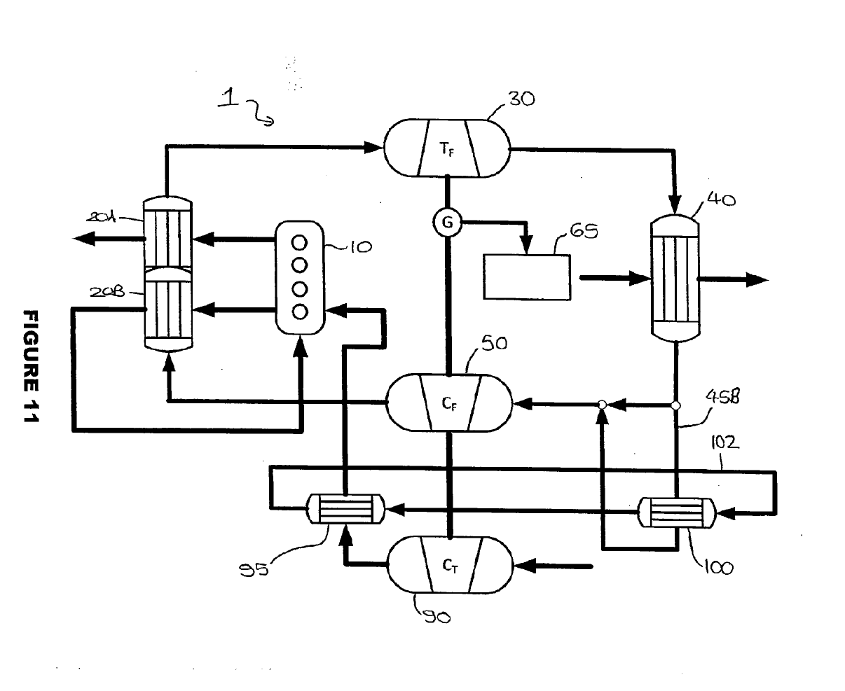

In an alternative embodiment shown in FIG. 11, a second intercooler 100 is arranged in series with the intercooler 95 in a closed loop water conduit 102. The second intercooler 100 is arranged upstream of the first intercooler 95 in the conduit portion 45B. As such, the supercritical working fluid does not pass through the intercooler 95 in this embodiment and cooling of the warmed compressed air exiting the air compressor 90 is provided by water within the water loop conduit 102. This embodiment allows a retrofit of the system 1 to an existing vehicle without replacing the turbo intercooler.

In each of the systems of FIGS. 10 and 11, the air compressor 90 is arranged on the same drive shaft as the compressor 50 for co-rotation therewith. As such, the supercritical fluid compressor 50 and the air compressor 90 are each directly powered by the turbine 30. Driving both compressors on the same shaft as the turbine removes the need to drive one or both compressors 50, 90 with a separate electric motor.

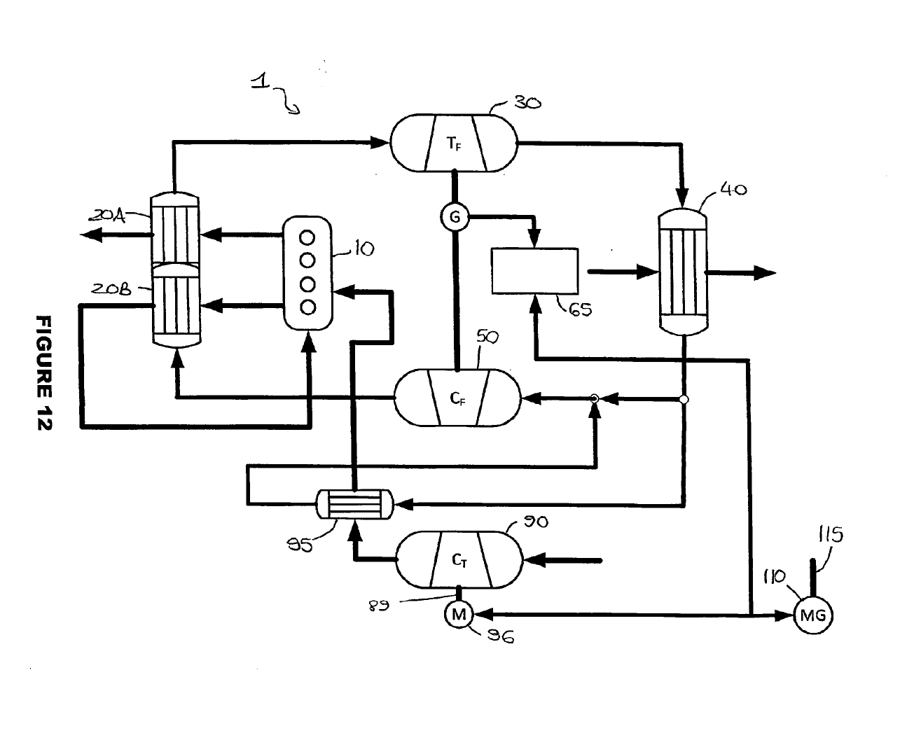

The system 1 of FIG. 12 includes a motor 96 arranged in electrical communication with the battery 65. The motor 96 draws electrical power from the battery 65 and converts it into shaft power for driving an input shaft 89 of the air compressor 90. Therefore, the air compressor 90 and the supercritical fluid compressor 50 can be driven at different rotational speeds from one another. In this embodiment, the working fluid of the intercooler 95 is supercritical fluid as in the system shown in FIG. 10. A portion of the electrical power stored in the battery 65 is also used to power a motor generator 110 for directly driving a drive shaft of the vehicle in which the internal combustion engine 10 is located. In this manner, the system can be used to assist in powering a hybrid engined vehicle such as a car.

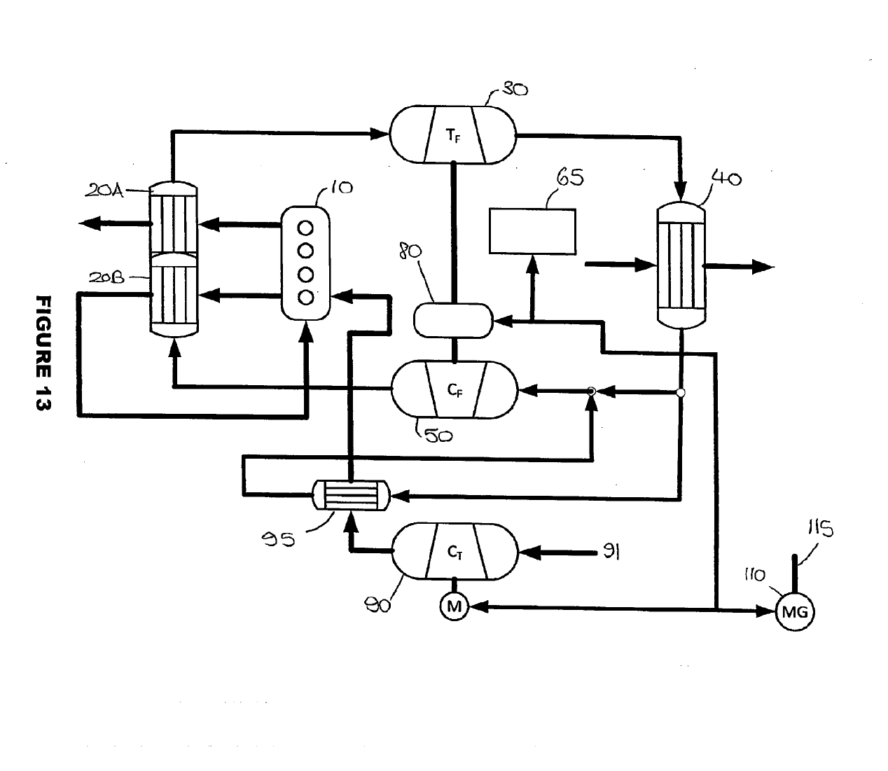

The system 1 shown in FIG. 13 is the same as that shown in FIG. 12, with the difference that the system includes a first digitally controlled motor device 80 as seen in the system of FIG. 8. The electrical power generated by the digitally controlled motor device 80 can be stored in the battery 65 for powering the air compressor 90. Alternatively or additionally, the digitally controlled motor device 80 is arranged in electrical communication with the motor generator 110 to directly power the motor generator 110 for propelling the vehicle drive shaft 115.

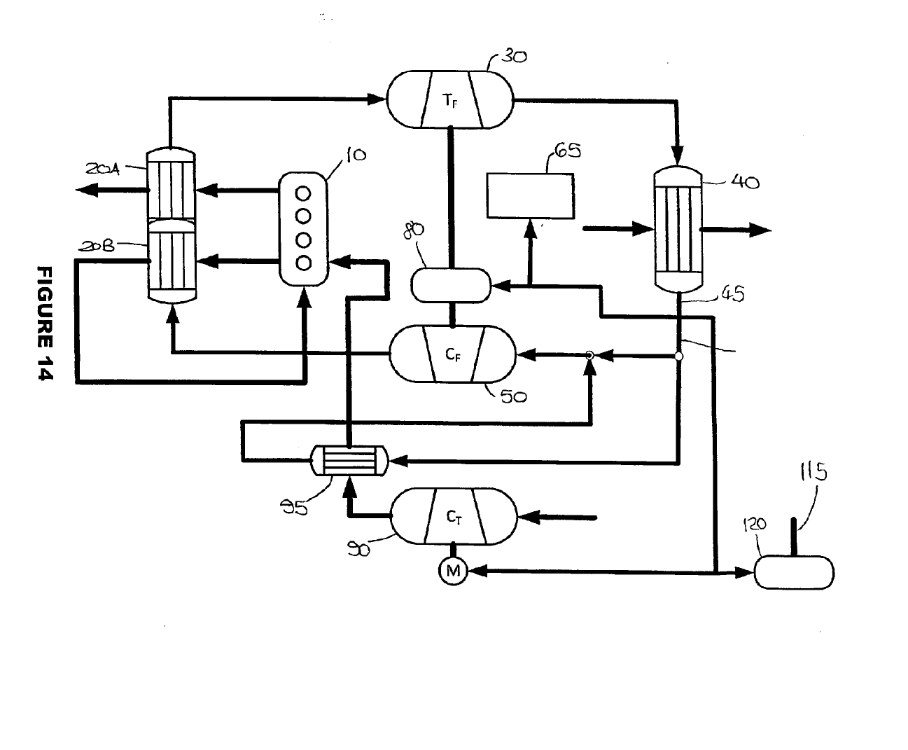

A preferred embodiment of the system 1 is shown in FIG. 14. The system 1 is identical to that of FIG. 13 with the addition of a second digitally controlled motor device with storage 120 in place of the motor generator 110 for driving the vehicle drive shaft 115. In this case, the second digitally controlled motor device 120 is configured to utilise the electrical power stored in the battery 65 and/or in the first digitally controlled motor device 80 and convert it to shaft power to drive the vehicle drive shaft 115. The use of the digitally controlled motor device 120 allows for more precise control of the speed of rotation of the drive shaft 115. An advantage of this embodiment is in allowing operation of the turbine 30 at its optimal speed for greatest efficiency with the compressor 50 operating at a different speed and also at its optimal speed for greatest efficiency.

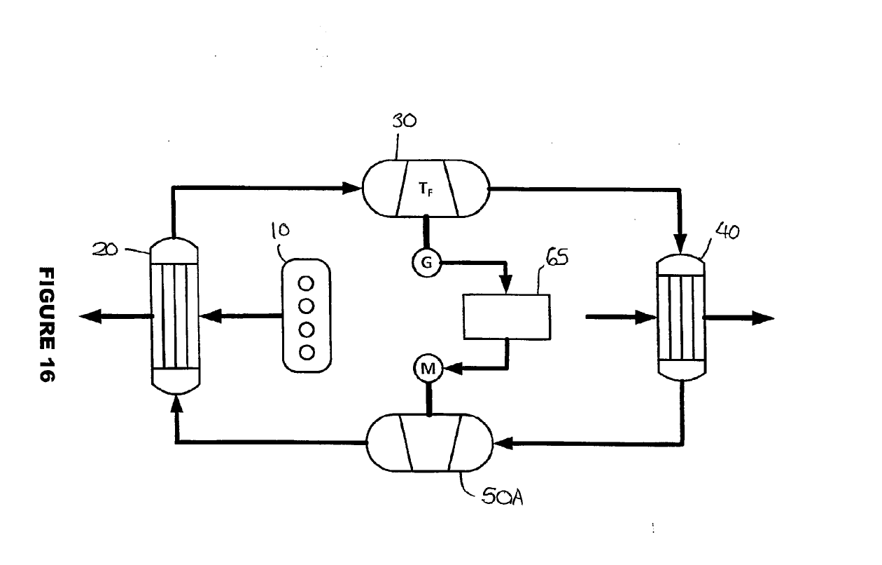

A portion of the cooled supercritical fluid in the transport conduit 45 can be diverted via a further heat exchanger 140 having water as a working fluid. The water cooled by the supercritical fluid in the heat exchanger 140 is supplied to a driver cooling device (not shown). Such a device may include water circulation tubes installed in the racing overalls of a driver or other appropriate means of supplying the cooled water to the driver. This embodiment is particularly suitable for use in motor racing vehicles such as Formula 1 cars in which drivers operate in a hot environment. The electrical or mechanical power stored in the battery 65 can be used to operate a compressor of an air conditioning system of the car. In an embodiment, the supercritical working fluid may be water. The supercritical fluid may become subcritical at one or more stages of the working fluid circuit, for example in the turbine 30 or at the cold heat exchanger 40. Accordingly, in the embodiment shown in FIG. 16, the first compressor 50 is replaced with a heat pump 50a for increasing the pressure of the working fluid downstream of the cold heat exchanger 40.

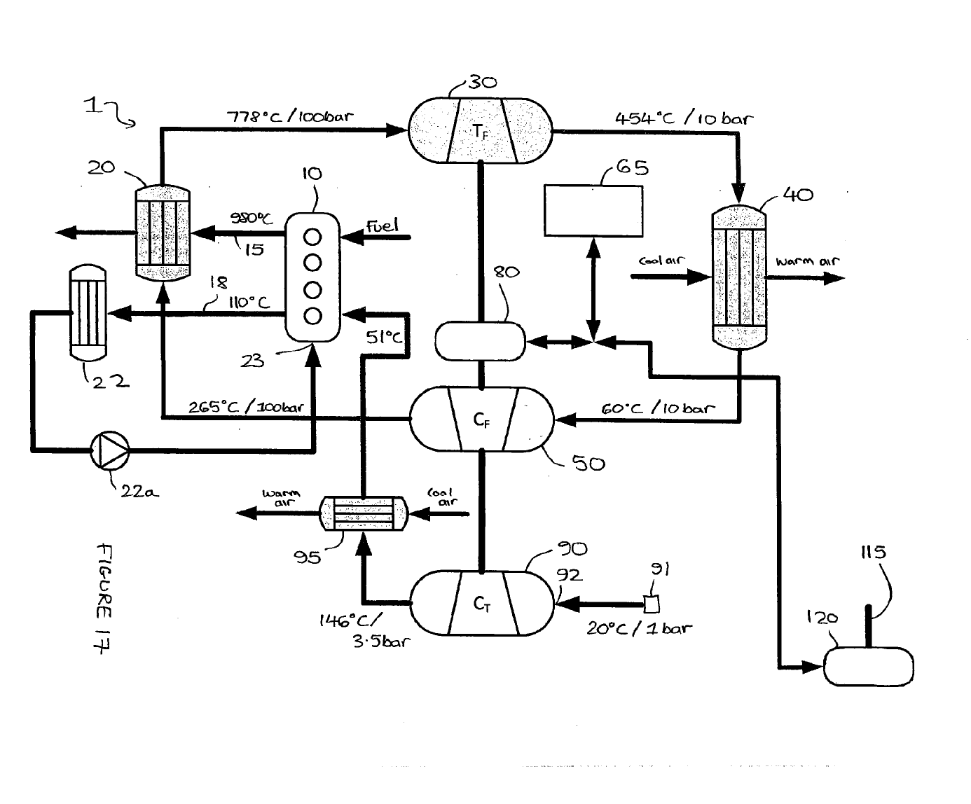

The system shown in FIG. 17 is a variation of the system of FIG. 10. The engine coolant exiting the internal combustion engine 10 in the coolant conduit 18 is no longer passed through a heat exchanger 20A for use in heating the working fluid. The engine coolant is instead passed through an intercooler such as a radiator 22 and then pumped back into the coolant intake 23 of the internal combustion engine 10 by a pump 22a. The motor generator 60 located on the output shaft of the turbine 30 is replaced with a digitally controlled motor device 80 for driving the first compressor 50 and the air compressor 90 or for storing its electrical power in the battery 65. A second digitally controlled motor device 120 is arranged in electrical communication with the first digitally controlled motor device 80 and the battery 65. The digitally controlled motor device 120 is configured to utilise the electrical power stored in the battery 65 and/or in the first digitally controlled motor device 80 and convert it to shaft power to drive the vehicle drive shaft 115. An advantage of this system over that shown in FIG. 10 is that the system requires fewer components and has the potential to maximise power transfer to or from the first digitally controlled motor device 80 for boosting drive power (at the second digitally controlled motor device 120) or to force induce power to the internal combustion engine 10 via the second compressor 90, or both if power is also drawn from storage at the battery 65.

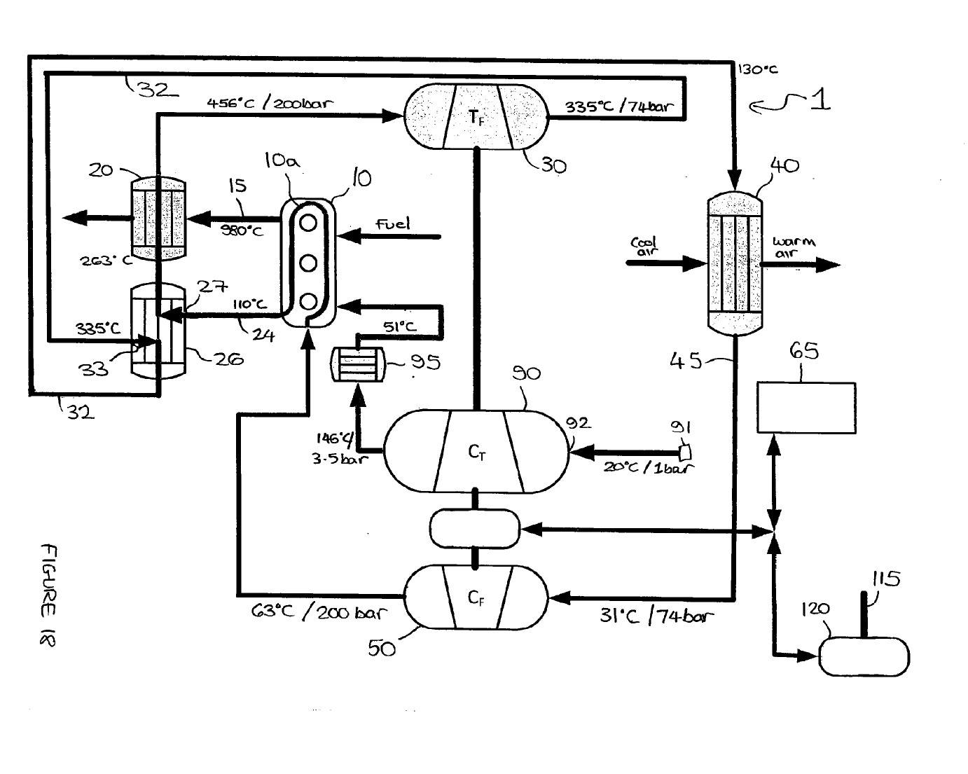

The system of FIG. 18 is a variation of the system of FIG. 17 in which the internal combustion engine 10 is utilised in the working fluid circuit. Upon exiting the first compressor 50, the working fluid is at a relatively cool temperature (approximately 60 degrees C.) and high pressure (approximately 200 bar). It is then passed through the internal combustion engine 10 via an engine conduit 10a that is arranged inside the engine in heat communication with at least one combustion cylinder of the engine (not shown) or with a quantity of hot engine oil (not shown) so as to heat the working fluid as it passes through the engine conduit 10a. The working fluid temperature at the exit of the engine conduit 10a is approximately 110 degrees C. The system of FIG. 18 further includes a recuperator 26 and a working fluid transport conduit 24 that extends between the engine conduit 10a and the recuperator 26. The recuperator 26 is a liquid to liquid tube in tube heat exchanger. The warmed working fluid exiting the engine conduit 10a is passed through the transport conduit 24 to an inlet 27 of the outer tube of the recuperator 26 where it is heated to approximately 260 degrees C. The working fluid then passes through the first heat exchanger 20 where it receives heat energy transferred from the hot engine exhaust from the exhaust conduit 15. As it exits the first heat exchanger 20, the working fluid is at a temperature of approximately 450 degrees C. The working fluid passes through the transport conduit 25 to the turbine 30 where it is expanded to a lower pressure and temperature, however the temperature remains high in comparison with the embodiment of FIG. 17 at approximately 330 degrees C. The high temperature working fluid is circulated back through the transport conduit 32 and through an inner tube 33 of the recuperator 26 where it transfers heat to the working fluid exiting the engine conduit 10a. From the recuperator 26, the working fluid flows through the transport conduit 32 to the second, cold, heat exchanger 40 and from there through the transport conduit 45 to the first compressor 50 as in the embodiments of FIGS. 10 and 17.

This embodiment of the system 1 is advantageous in that it is of lesser weight and complexity than the embodiment of FIG. 17. Furthermore, the working fluid directly absorbs extra heat as the engine is hot and the recuperator does a large amount of work similar to the heat exchanger 20. As such, the working fluid is at a much higher temperature as it enters the turbine 30 and the power output of the system is increased.

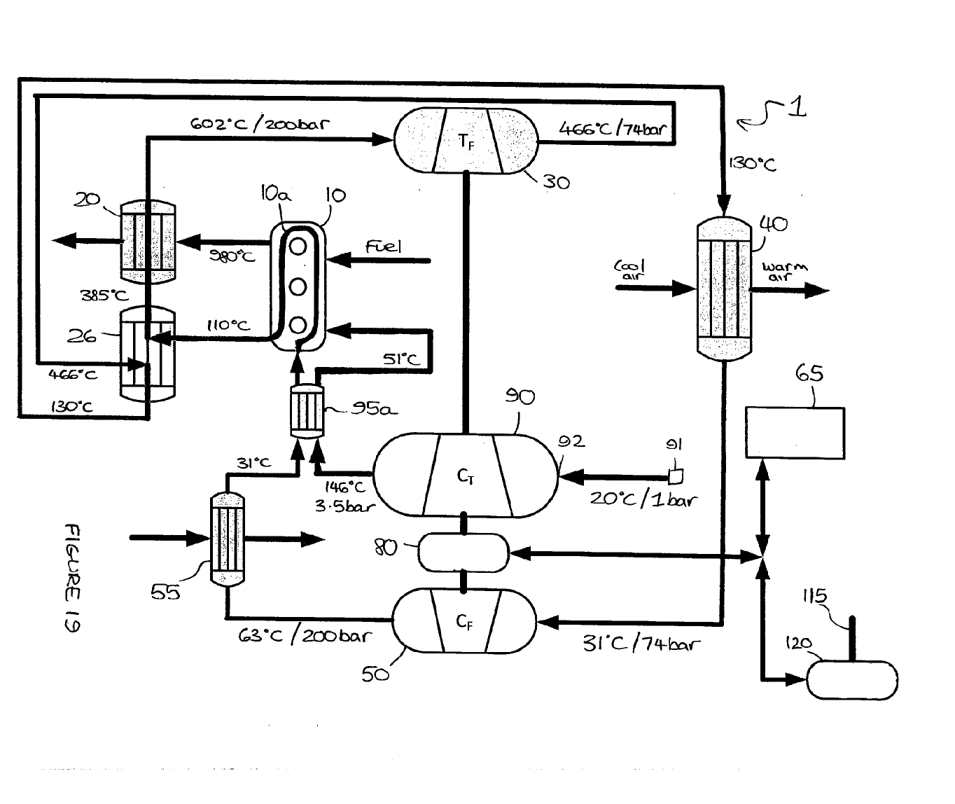

FIG. 19 shows a variation of the system of FIG. 18 in which the working fluid is passed through a third heat exchanger or aftercooler 55 as it exits the first compressor 50, reducing the temperature of the working fluid to about 30 degrees C. The system 1 includes air intercooler 95a in place of the intercooler 95. The working fluid is passed through the intercooler 95a where it absorbs heat from the warm compressed air passing therethrough before it enters the engine conduit 10a of the internal combustion engine 10. The air intercooler 95a employs the working fluid as a more effective heat exchange fluid than is found in the conventional intercooler 95 of the embodiment of FIG. 18 and reduces the overall weight and complexity of the system. It also results in a more constant reclaiming of heat by the working fluid which creates more power at lower engine RPM and allows faster acceleration of a vehicle in which the system 1 is utilised.

The system 1 is adapted be installed in a new vehicle or alternatively it can be retro-fitted to an existing vehicle.

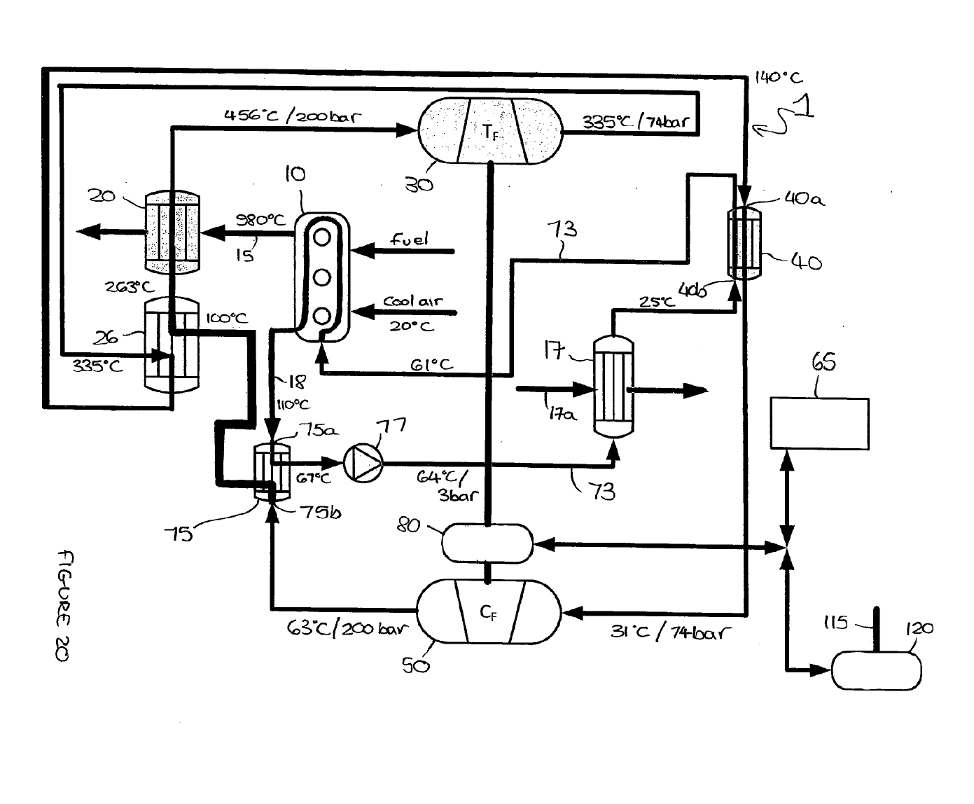

FIGS. 20 to 26 show various embodiments of the system that allow for retro-fitting of the system to an existing vehicle.

FIG. 20 shows a retrofit configuration of the heat energy recovery system for a normally aspirated engine. The air compressor 90 has been removed from the system and there is no turbocharging of the internal combustion engine 10. The system is therefore similar to that of the embodiment of FIG. 8, with an additional digitally controlled motor device 120 arranged to draw electrical power from the first digitally controlled motor device 80 or from the battery 65, to directly drive the vehicle crank shaft 115. The system of FIG. 20 includes a closed loop engine coolant circuit 73. The circuit 73 utilises a radiator 17 of the internal combustion engine 10 to provide some of the cooling load of the working fluid in the system 1. The system 1 also includes an additional heat exchanger 75 having a hot side 75a and a cold side 75b. The hot side 75a is arranged in fluid communication with the engine coolant conduit 18 at the start of the engine coolant circuit 73. Engine coolant exiting the engine 10 through the engine coolant conduit 18 passes through the hot side 75a of the heat exchanger 75 and is then pumped through the radiator 17 by a pump 77 where it is cooled by a cool air stream 17a flowing through the radiator 17. The cooled engine coolant is then passed through a cold side 40b of the second heat exchanger 40 where it absorbs heat from the working fluid passing through the hot side 40a thereof. The engine coolant is therefore used to cool the working fluid as it passes through the second heat exchanger 40. The warmed coolant is then passed back into the water coolant intake 73 of the engine 10 to complete the circuit. An advantage of this configuration is that it utilises existing vehicle components and therefore minimises cost in comparison to some other embodiments.

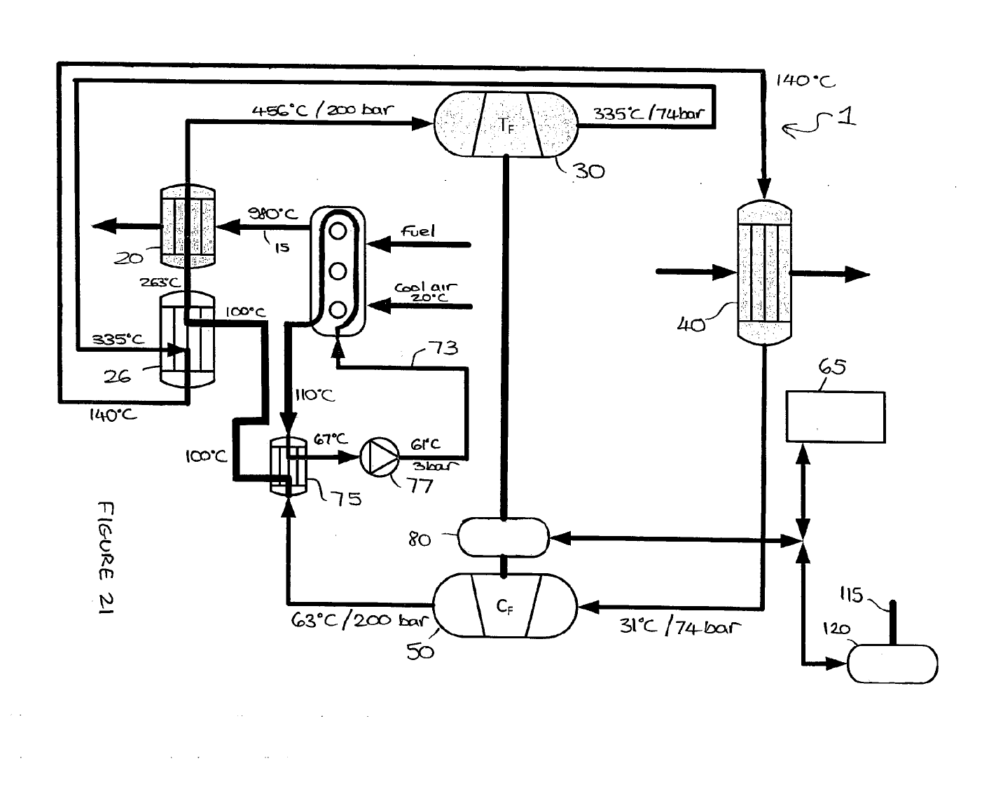

The system of FIG. 21 is a similar configuration to that of FIG. 20. In this embodiment however, the radiator 17 is not utilised in the engine coolant circuit 73. The cooling of the working fluid is undertaken completely by the second heat exchanger 40 using a cool air supply 40c. The engine coolant is pumped by pump 77 directly back into the internal combustion engine 10 after it exits the additional heat exchanger 75. It is envisaged that the second heat exchanger 40 used in this embodiment is likely to be more efficient, lighter, smaller in size and more powerful than the radiator 17 of the vehicle to which the system 1 is fitted, resulting in increased performance for less system weight.

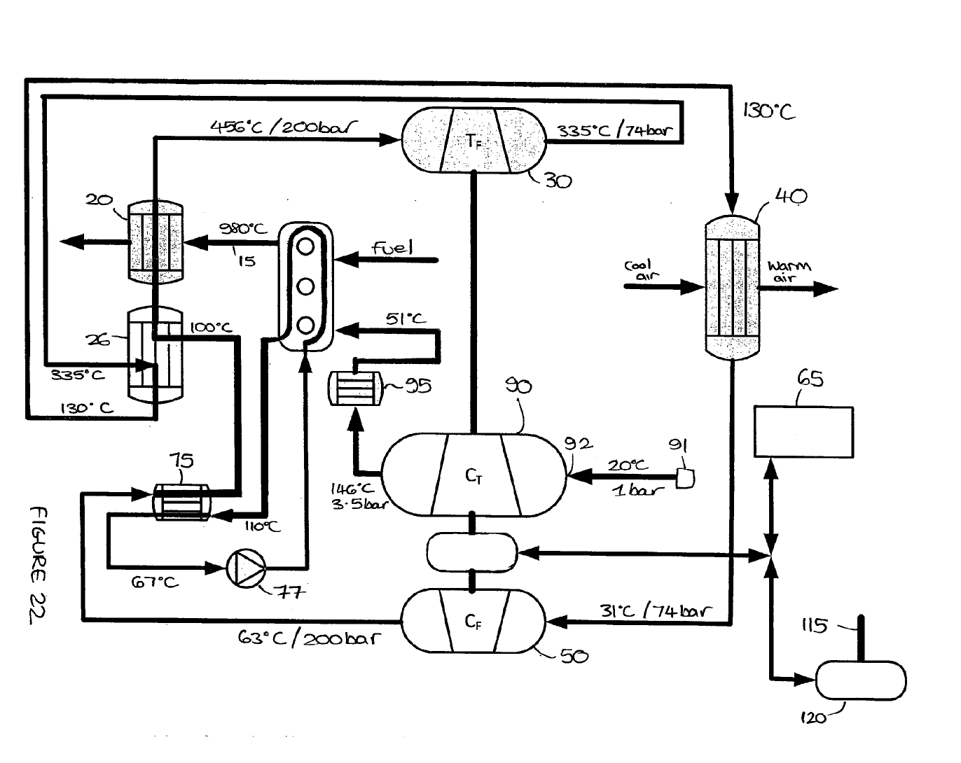

The system shown in FIG. 22 is similar to the system shown in FIG. 18. However, there is no engine conduit 10a in the internal combustion engine 10 through which the working fluid may pass. Instead, the system 1 includes the additional heat exchanger 75 and the pump 77 of the system of FIGS. 20 and 21. The working fluid passes through the cold side 75b of the additional heat exchanger 75 and bypasses the engine 10 to flow directly through the recuperator 26 and then through the first heat exchanger 20. Warm engine coolant is circulated through the hot side 75a of the additional heat exchanger 75 where it transfers heat to the working fluid before being pumped by the pump 77 back into the engine 10. This embodiment has the advantage that the internal combustion engine 10 does not need to be redesigned to accommodate the working fluid in the engine conduit 10a and can operate as normal with engine coolant. The additional heat exchanger 75 reclaims and transfers the waste heat from the engine coolant to the working fluid. The system 1 is therefore simple and has a reduced cost compared to some other embodiments.

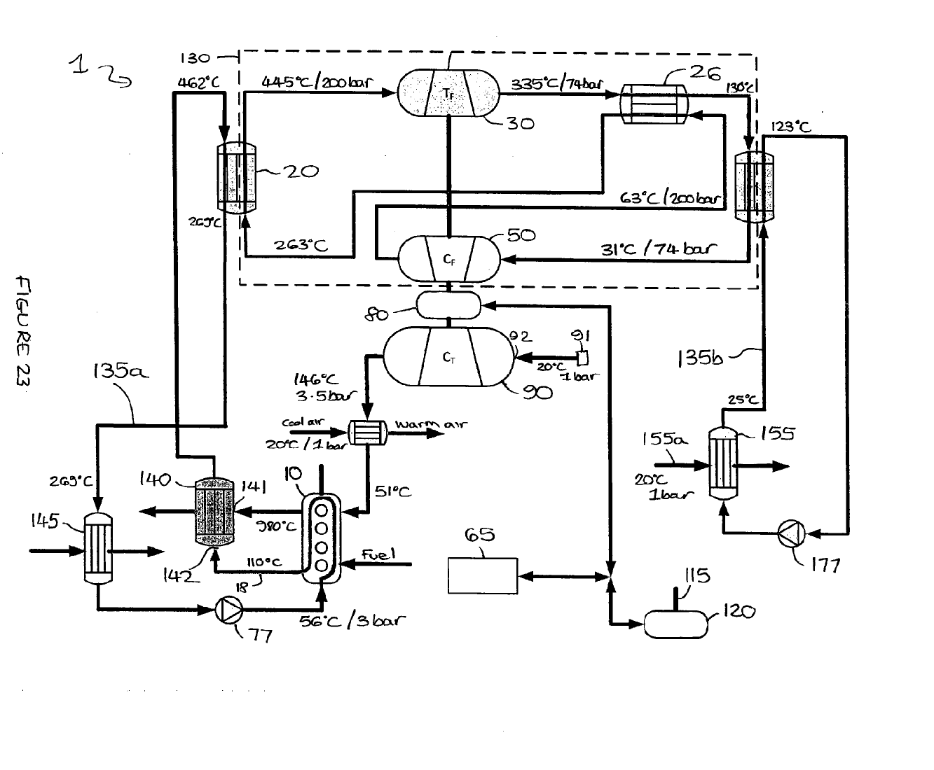

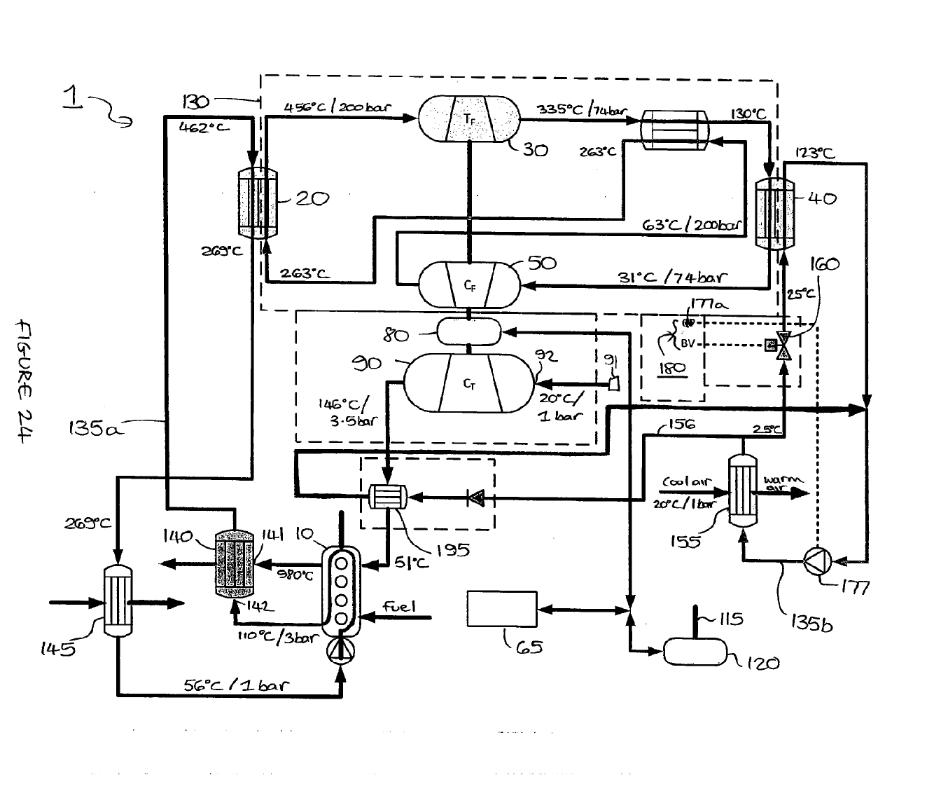

In the system shown in FIGS. 23 and 24, the main components of the heat energy recovery system 1 is contained in a single unit 130 and consists of the first heat exchanger 20, turbine 30, recuperator 25, second heat exchanger 40 and first compressor 50. The unit 130 is, in a preferred embodiment, machined from a single billet of metal and is intended to better withstand the high pressures within the system, which can reach up to 200 bar.

Outside of the system unit 130, a first coolant circuit 135a and a second coolant circuit 135b provide a heat transfer medium in each of the first heat exchanger 20 and the second heat exchanger 40. The first coolant circuit 135a includes an intermediary exhaust heat exchanger 140 (separate to the first heat exchanger 20), a “hot” radiator 145 and the pump 77. In the first coolant circuit 135a, the engine coolant is warmed in the engine 10 and is diverted therefrom into the coolant conduit 18. The coolant conduit 18 is in heat and fluid communication with an inlet 141 of the exhaust heat exchanger 140, which is in turn in heat and fluid communication with the inner tube of the heat exchanger 140. The exhaust conduit 15 of the internal combustion engine 10 extends from the engine exhaust to an inlet 142 of the exhaust heat exchanger 140, which in turn is in heat and fluid communication with an outer tube of the heat exchanger 140. The outer tube of the heat exchanger 140 receives the hot exhaust flow from the engine exhaust conduit 15, which then exits the exhaust heat exchanger 140 to the atmosphere. The engine coolant passes through the inner tube of the heat exchanger 140 and absorbs heat from the high temperature exhaust flow in the outer tube. At temperatures as high as 460 degrees C., the coolant is then passed through the hot side of the first heat exchanger 20 to provide heat energy to the working fluid passing through the cold side of the heat exchanger 20. The cooled coolant is then passed through the radiator 145 where it cools further before it is pumped by the pump 77 back into the coolant intake 23 of the internal combustion engine 10.

The second coolant circuit 135b consists of a “cold” radiator 155 and a “cold” pump 177. A suitable coolant, such as water, is pumped by the pump 177 through the radiator 155 where it is cooled by a cold air stream 155a. The cooled coolant is passed through the cold side of the second heat exchanger 40 to provide cooling to the working fluid passing through the hot side before being pumped through the radiator 155 again to complete the circuit. The air stream 155a, having absorbed heat energy from the coolant in the radiator 155, is exhausted to the atmosphere.

The unit 130 is set into operation by providing hot coolant through the hot side of the first heat exchanger 20 to heat the supercritical working fluid and by providing cold coolant in the cold side of the second heat exchanger 40 to power the turbine 30. The system also includes the air compressor 90 and the air to air intercooler 95a for the supply of compressed air into the internal combustion engine 10 and first and second digitally controlled motor devices 80, 120 as in the embodiments of FIGS. 18, 20, 21 and 22. An advantage of this embodiment is that the unit 130 can be located anywhere suitable within the vehicle in which it is being utilised, as the first digitally controlled motor device 80 can be located separately to it. The unit 130 can be mass produced and therefore costs can be reduced if units are manufactured at sufficient scale.

The efficiency of the heat energy recovery system unit 130 can be controlled by controlling the hottest temperature of the working fluid in the first hot heat exchanger 20 and the coldest temperature of the working fluid in the second cold heat exchanger 40. This in turn can be controlled by the temperature of the coolant passing through the hot side of the first hot heat exchanger 20 and passing through the cold side of the second hot heat exchanger 40 and which will provide heat energy to the working fluid. This arrangement has the advantage of simple speed control for fixed speed applications of the heat energy recovery system 1 such as diesel generators and also serves as an additional power control function when used with the MGU-H system in a Formula 1 racing car.

The embodiment of FIG. 24 is a variation of the embodiment of FIG. 23 in which the air to air intercooler 95 is replaced by a liquid to air intercooler 195, which is smaller and lighter than the intercooler 95. The second coolant circuit 135b now includes a bypass valve 160 in the coolant flow path between the cold radiator 155 and the second heat exchanger 40. The coolant circuit 135b splits off downstream of the radiator 155 to a branch conduit 156 that carries a portion of the coolant in the coolant circuit 135b towards and through the intercooler 195 for use in cooling the compressed air exiting the compressor 90 prior to its entry into the air intake of the internal combustion engine 10. The use of coolant or water in the intercooler 195 is more efficient in cooling the compressed air than the use of air in the intercooler 95. The cold pump 177 has a speed controller 177a. The speed controller 177a of the cold pump 177 and the opening and closing of the bypass valve 160 can be controlled electronically or wirelessly at a controller 180 as shown schematically in FIG. 24 to control the amount of coolant that is provided to the intercooler 195 and to the second heat exchanger 40, and which can be used to force more coolant to either one. This embodiment has the advantage of less weight than the system of FIG. 23 by using the smaller intercooler 195 and provides greater performance and control than the system of FIG. 23. The hot pump 177 is driven by the internal combustion engine 10 in this embodiment. Both this and the use of the intercooler 195 allow easier retrofitting of this embodiment to existing internal combustion engines.

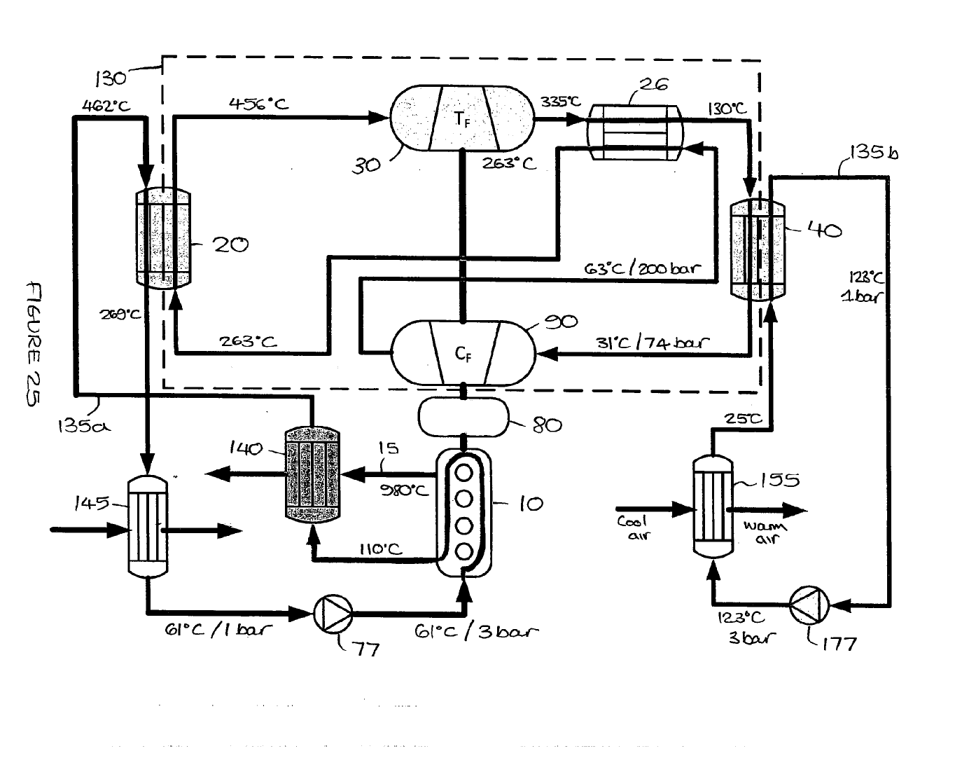

FIG. 25 shows a further variation of the system of FIG. 23. In this embodiment, the air compressor 90 and the intercooler 95 are no longer present and the internal combustion engine 10 is naturally aspirated. The internal combustion engine 10 is connected to the heat energy recovery system 1 by the first digitally controlled motor device 80 such that the system 1 can provide power directly to the internal combustion engine 10. The digitally controlled motor device 80 operates either as a gearbox, if a reduction in speed is required, or it can be driven directly at the same speed as the internal combustion engine 10. This direct drive embodiment is easily retrofitted to existing internal combustion engines, in particular fixed speed engines such as diesel engines, hydraulic engines and other large internal combustion engines. The power generated from the heat energy recovery from the internal combustion engine 10 can be added directly to the power generated at the crank shaft of the internal combustion engine 10.

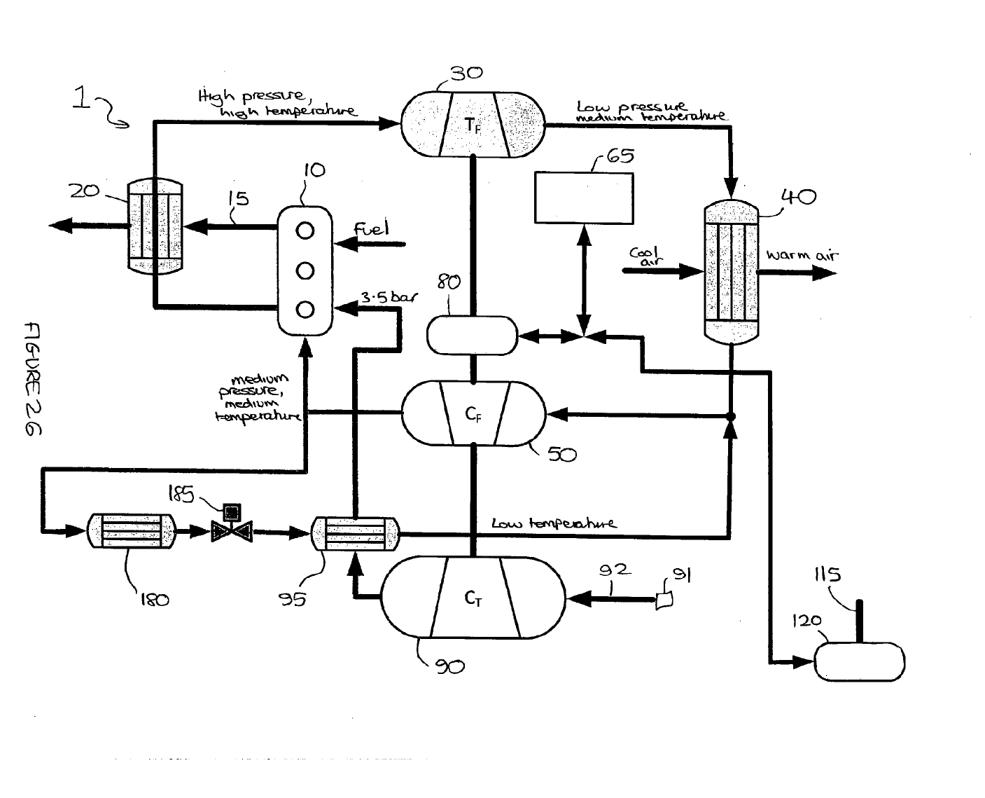

The system shown in FIG. 26 is a variation of the system of FIG. 17 that includes a subcooler 180 and an electronic expansion valve (EEV) 185 in the working fluid circuit. The working fluid exiting the first compressor 50 is passed through the subcooler 180 and then through the EEV 185. The EEV 185 is used to control the expansion of the gas inside the intercooler 95. The latent heat of vaporisation of the expansion of the liquid to gas absorbs a greater amount of heat at a greater capacity and further cools the compressed air from the turbo compressor 90 passing through the intercooler 95 to below ambient temperature. The colder compressed air creates greater expansion of gases in the combustion process within the cylinders of the internal combustion engine 10 and increases its power output. This in turn increases the efficiency of the combustion process and reduces fuel consumption.

It will be appreciated that all indications of temperature and pressure have been provided for guidance only and are not limiting for the purpose of the invention.

Although the invention has been described with reference to specific examples, it will be appreciated by those skilled in the art that the invention may be embodied in many other forms.

1. An internal combustion engine heat energy recovery system, comprising:
a first heat exchanger arranged in heat communication, more preferably fluid communication, with at least one heat energy source of an internal combustion engine and with a working fluid of the system for the transfer of heat energy from the heat energy source to the working fluid of the system;
a turbine arranged in fluid communication with the working fluid heated in the first heat exchanger for the expansion of the working fluid to produce shaft power;
a second heat exchanger arranged in heat communication, more preferably fluid communication, with the expanded working fluid to remove waste heat therefrom and transfer it to an external source such as the atmosphere; and a first compressor arranged in fluid communication with the working fluid exiting the heat exchanger for increasing the pressure of the cooled working fluid prior to its entry into the first heat exchanger, wherein the working fluid of the system is a supercritical fluid.

2. An internal combustion engine heat energy recovery system, comprising:
a first heat exchanger arranged in heat communication, more preferably fluid communication, with a first heat energy source of an internal combustion engine and with a second heat energy source of the internal combustion engine for the transfer of heat energy from the first heat energy source to the second heat energy source;
an intermediary heat exchanger arranged in heat communication with the second heat energy source heated in the first heat exchanger and with a working fluid of the system for the transfer of heat energy from the second heat energy source to the working fluid of the system;
a turbine arranged in fluid communication with the working fluid heated in the intermediary heat exchanger for the expansion of the working fluid to produce shaft power;
a second heat exchanger arranged in heat communication, more preferably fluid communication, with the expanded working fluid to remove waste heat therefrom and transfer it to an external source such as the atmosphere; and a first compressor arranged in fluid communication with the working fluid exiting the heat exchanger for increasing the pressure of the cooled working fluid prior to its entry into the intermediary heat exchanger, wherein the working fluid of the system is a substantially supercritical fluid.

3. The internal combustion engine heat energy recovery system of claim 1 or claim 2, wherein the working fluid is supercritical carbon dioxide.

4. The internal combustion engine heat energy recovery system of claim 1 or claim 2, wherein the working fluid is supercritical water or other refrigerant.

5. The internal combustion engine heat energy recovery system of any one of claims 1 to 4, wherein the system includes a generator operatively associated with the turbine for converting the shaft power produced by the turbine into electrical power.

6. The internal combustion engine heat energy recovery system of claim 5, wherein the system includes a battery adapted for storing the electrical power generated by the generator.

7. The internal combustion engine heat energy recovery system of any one of claims 1 to 6, wherein the at least one or first heat energy source of the internal combustion engine is exhaust gas.

8. The internal combustion engine heat energy recovery system of any one of claims 1 to 7, wherein the at least one heat energy source or second heat energy source of the internal combustion engine is engine coolant.

9. The internal combustion engine heat energy recovery system of claim 8, wherein the system includes a coolant recirculation conduit arranged to recirculate engine coolant cooled by the first heat exchanger back to the internal combustion engine.

10. The internal combustion engine heat energy recovery system of claim 9, wherein the coolant recirculation conduit is arranged to recirculate the engine coolant in a water circuit inside the engine.

11. The internal combustion engine heat energy recovery system of claim 9, wherein a water circuit is arranged inside the engine for circulation of the working fluid.

12. The internal combustion engine heat energy recovery system of any one of claims 1 to 12, wherein the at least one or first heat energy source of the internal combustion engine is engine oil.

13. The internal combustion engine heat energy recovery system of claim 12, wherein the system includes an engine oil recirculation conduit arranged to recirculate engine oil cooled by the first heat exchanger back to the internal combustion engine.

14. The internal combustion engine heat energy recovery system of claim 13, wherein the engine oil recirculation conduit is arranged to recirculate engine oil back inside the engine in an oil circuit.

15. The internal combustion engine heat energy recovery system of any one of claims 1 to 14, wherein the at least one heat energy source is condenser heat emitted by the air conditioning system of a vehicle.

16. The internal combustion engine heat energy recovery system of any one of claims 1 to 15, wherein the system is arranged to recover heat energy from a plurality of heat energy sources of the internal combustion engine.

17. The internal combustion engine heat energy recovery system of claim 16, wherein the first heat exchanger is arranged in heat communication, more preferably fluid communication, with each of a first heat energy source in the form of engine exhaust gas and a second heat energy source in the form of engine coolant.

18. The internal combustion engine heat energy recovery system of claim 17, wherein the first heat exchanger comprises an exhaust gas receiving heat exchanger for the transfer of heat energy from the exhaust gas to the working fluid, and a coolant receiving heat exchanger for the transfer of heat energy from the engine coolant to the working fluid.

19. The internal combustion engine heat energy recovery system of claim 17 or claim 18, wherein the first heat exchanger further includes an oil receiving heat exchanger arranged in heat communication, more preferably fluid communication, with a further heat energy source in the form of engine oil for the transfer of heat energy from the engine oil to the working fluid.

20. The internal combustion engine heat energy recovery system of any one of claims 1 to 19, wherein the first compressor is operatively associated with an output shaft of the turbine so as to be driven by the turbine.

21. The internal combustion engine heat energy recovery system of any one of claims 6 to 19, wherein the system includes a motor arranged to draw electrical power from the battery.

22. The internal combustion engine heat energy recovery system of claim 21, wherein the first compressor is operatively associated with and driven by the motor.

23. The internal combustion engine heat energy recovery system of any one of claims 1 to 19, in which the first compressor is driven by shaft power produced by the internal combustion engine.

24. The internal combustion engine heat energy recovery system of claim 5, wherein the first compressor is driven directly by the electrical power generated by the generator.

25. The internal combustion engine heat energy recovery system of claim 5, wherein the system further includes a digitally controlled motor device with storage arranged to draw electrical power from the generator.

26. The internal combustion engine heat energy recovery system of claim 25, wherein the digitally controlled motor device comprises a fly wheel for the storage of mechanical power.

27. The internal combustion engine heat energy recovery system of claim 25 or 26, wherein the digitally controlled motor device further includes a rotor arranged in magnetic communication with the fly wheel.

28. The internal combustion engine heat energy recovery system of claim 27, wherein the fly wheel and the rotor are adapted to operate at different speeds of rotation.

29. The internal combustion engine heat energy recovery system of any one of claims 25 to 28, wherein at least a portion of electrical power generated by the digitally controlled motor device is employed to drive the first compressor.

30. The internal combustion engine heat energy recovery system of any one of claims 25 to 28 when dependent upon claim 6, wherein the digitally controlled motor device is arranged to divert at least a portion of electrical power generated therein to the battery for storage.

31. The internal combustion engine heat energy recovery system of any one of claims 1 to 30, wherein the system further includes a second compressor in fluid communication with an air supply and a first intercooler arranged for cooling compressed air exiting the second compressor, wherein the cooled compressed air is arranged in fluid communication with an intake of the internal combustion engine.

32. The internal combustion engine heat energy recovery system of claim 31, wherein a portion of the working fluid cooled by the second heat exchanger is diverted through the intercooler prior to its entry into the first compressor for cooling the compressed air.

33. The internal combustion engine heat energy recovery system of claim 31, wherein the system includes a second intercooler in heat communication, more preferably fluid communication, with the first intercooler, the first intercooler and second intercooler being arranged in a closed loop through which an intercooler fluid flows, wherein a portion of the working fluid cooled by the second heat exchanger is diverted through the second intercooler for heat exchange with the intercooler fluid prior to its entry into the first compressor.

34. The internal combustion engine heat energy recovery system of claim 33, wherein the intercooler fluid is water.

35. The internal combustion engine heat energy recovery system of claim 31 when dependent upon claim 5, wherein the second compressor is driven directly by electrical power generated by the generator.

36. The internal combustion engine heat energy recovery system of claim 31 when dependent upon claim 6, wherein the second compressor is driven by a motor powered by electrical power stored in the battery.

37. The internal combustion engine heat energy recovery system of any one of claims 7 to 34 when dependent upon claim 6, wherein the system further includes a motor generator powered by a portion of the electrical power stored in the battery.

38. The internal combustion engine heat energy recovery system of claim 37, wherein the motor generator is operatively associated with a drive shaft of a vehicle powered by the internal combustion engine.

39. The internal combustion engine heat energy recovery system of claim 37 or claim 38, wherein the motor generator is adapted to draw electrical power from the battery to rotate a drive shaft of the vehicle.

40. The internal combustion engine heat energy recovery system of any one of claims 31 to 39 when dependent upon claim 25, wherein a portion of the electrical power generated by the digital gearbox motor is used to drive the first compressor and another portion of the electrical power is used to drive the second compressor.

41. The internal combustion engine heat energy recovery system of any one of claims 30 to 40 when dependent upon claim 6, further including a first digitally controlled motor device with storage arranged in operable communication with both the turbine and the first compressor for driving the first compressor and further includes a second digitally controlled motor device with storage operatively associated with the drive shaft of the vehicle and adapted to draw electrical power from the battery to rotate the drive shaft of the vehicle.

42. The internal combustion engine heat energy recovery system of any one of claims 1 to 41, wherein the working fluid is circulated through the internal combustion engine in heat communication with at least one engine component for the transfer of heat energy from the at least one engine component to the working fluid prior to its entry into the first heat exchanger.

43. The internal combustion engine heat energy recovery system of claim 42, wherein the at least one engine component is a combustion cylinder.

44. The internal combustion engine heat energy recovery system of claim 42, wherein the at least one engine component is engine oil.

45. The internal combustion engine heat energy recovery system of any one of claims 1 to 44, further comprising a recuperator arranged in heat communication, preferably fluid communication, with the working fluid upon its exit from the internal combustion engine for the transfer of heat energy to the working fluid prior to its entry into the first heat exchanger.

46. The internal combustion engine heat energy recovery system of claim 45, wherein the recuperator is also arranged in heat communication, preferably fluid communication, with the expanded working fluid for the transfer of heat energy from the working fluid prior to its entry into the second heat exchanger.

47. The internal combustion engine heat energy recovery system of claim 44 or claim 45 when dependent on claim 2, wherein the recuperator is arranged in heat communication, preferably fluid communication, with the working fluid upon its exit from the first compressor for the transfer of heat energy to the working fluid prior to its entry into the intermediary heat exchanger.

48. The internal combustion engine heat energy recovery system of claim 47, wherein the recuperator is also arranged in heat communication, preferably fluid communication, with the expanded working fluid for the transfer of heat energy from the working fluid prior to its entry into the second heat exchanger.

49. There is further disclosed herein an internal combustion engine heat energy recovery system, comprising:
an internal combustion engine heat exchanger arranged in heat communication with at least one component of the internal combustion engine for the transfer of heat energy from the at least one component of the internal combustion engine to a working fluid of the system, a first heat exchanger arranged in heat communication, more preferably fluid communication, with the working fluid heated by the internal combustion heat exchanger and in heat communication, preferably fluid communication, with at least one further heat energy source of the internal combustion engine for the transfer of heat energy from the heat energy source to the working fluid of the system;
a turbine arranged in fluid communication with the working fluid heated in the first heat exchanger for the expansion of the working fluid to produce shaft power;
a recuperator arranged in fluid communication with the expanded working fluid from the turbine to recuperate the heat therein, and further being arranged in fluid communication with the working fluid heated by the internal combustion engine heat exchanger to cool the working fluid prior to its entry into the first heat exchanger;
a second heat exchanger arranged in fluid communication with the working fluid heated in the recuperator for the removal of waste heat therefrom and transfer it to an external source such as the atmosphere; and
a first compressor arranged in fluid communication with the working fluid exiting the second heat exchanger for increasing the pressure of the cooled working fluid prior to its entry into the internal combustion engine heat exchanger, wherein the working fluid of the system is a supercritical fluid.

50. The internal combustion engine heat energy recovery system of claim 49, wherein the internal combustion engine heat exchanger is or includes a conduit arranged in heat communication with the at least one component of the internal combustion engine.

51. The internal combustion engine heat energy recovery system of claim 50, wherein the conduit is arranged to transport the working fluid through the internal combustion engine.

52. The internal combustion engine heat energy recovery system of claim 49, further including a third heat exchanger in fluid communication with the working fluid exiting the first compressor, in which the working fluid passing through the third heat exchanger is in heat communication with ambient air for cooling the working fluid.

53. The internal combustion engine heat energy recovery system of claim 52, further comprising a second compressor in fluid communication with an air supply and a first intercooler arranged for cooling compressed air exiting the second compressor, wherein the cooled compressed air is in heat communication with the working fluid exiting the third heat exchanger for cooling the compressed air prior to its entry into the internal combustion engine.

54. The internal combustion engine heat energy recovery system of any one of claims 49 to 53, wherein the internal combustion engine heat exchanger is located inside the internal combustion engine.

55. The internal combustion engine heat energy recovery system of any one of claims 49 to 54, wherein the at least one engine component is either a combustion cylinder or engine oil.

56. The internal combustion engine heat energy recovery system of any one of claims 49 to 55, wherein the second heat exchanger is arranged to transfer the waste heat from the working fluid to the atmosphere.

57. An internal combustion engine heat energy recovery system, comprising:
a first heat exchanger arranged in heat communication, more preferably fluid communication, with at least one heat energy source of an internal combustion engine and with a working fluid of the system for the transfer of heat energy from the heat energy source to the working fluid of the system;
a turbine arranged in fluid communication with the working fluid heated in the first heat exchanger for the expansion of the working fluid to produce shaft power;
a second heat exchanger arranged in heat communication, more preferably fluid communication, with the expanded working fluid to remove waste heat therefrom and transfer it to the atmosphere; and a first compressor arranged in fluid communication with the working fluid exiting the heat exchanger for increasing the pressure of the cooled working fluid prior to its entry into the first heat exchanger, wherein the working fluid of the system is a substantially supercritical fluid.

58. An internal combustion engine heat energy recovery system, comprising:
a first heat exchanger arranged in heat communication, more preferably fluid communication, with at least one heat energy source of an internal combustion engine and with a working fluid of the system for the transfer of heat energy from the heat energy source to the working fluid of the system;
a turbine arranged in fluid communication with the working fluid heated in the first heat exchanger for the expansion of the working fluid to produce shaft power;
a second heat exchanger arranged in heat communication, more preferably fluid communication, with the expanded working fluid to remove waste heat therefrom and transfer it to the atmosphere; and a first pressurising device arranged in fluid communication with the working fluid exiting the heat exchanger for increasing the pressure of the cooled working fluid prior to its entry into the first heat exchanger, wherein the working fluid of the system is a substantially supercritical fluid.

59. The internal combustion engine heat energy recovery system of claim 58, wherein the pressurising device is a heat pump.

60. The internal combustion engine heat energy recovery system of any one of claims 1 to 60, wherein the working fluid is supercritical at least prior to its entry into the turbine.
